(19) United States
(12) Patent Application Publication
(10) Pub. No.: US 2007/0058250 A1
(43) Pub. Date: Mar. 15, 2007

(54) Optical film, antireflection film, polarizing plate using the same and display device

(75) Inventor: Yuuzou Muramatsu, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-Ashigara-shi (JP)

(21) Appl. No.: 11/519,767

(22) Filed: Sep. 13, 2006

(30) Foreign Application Priority Data
Sep. 15, 2005 (JP) 2005-268615

(51) Int. Cl. G02B 5/30

(52) U.S. Cl. 359/483

(57) ABSTRACT

An optical film comprises: a transparent support; and a light-diffusing layer comprising a first light-transparent resin particle and a binder, wherein the first light-transparent resin particle has an average particle diameter of from 5 to 15 μm, the light-diffusing layer has a film thickness of from 8 to 30 μm, and a haze of a surface, on the side coated with the light-diffusing layer, of the optical film is from 0 to 10%.

### BACKGROUND OF THE INVENTION

1. Field of the Invention

The present invention relates to an optical film, an antireflection film, a polarizing plate using the same, and a display device using the same.

2. Description of the Related Art

With recent increase in the screen size of a liquid crystal display device (LCD), a liquid crystal display device having disposed thereon an optical film such as antireflection film and light-diffusing sheet is increasing. For example, in various image display devices such as liquid crystal display device (LCD), plasma display panel (PDP), electroluminescent display (ELD) and cathode ray tube display device (CRT), the antireflection film is disposed on the surface of the display so as to prevent the reduction in contrast due to reflection of outside light or projection of an image. Also, the light-diffusing sheet is used for the backlight of a liquid display device.

The antireflection film which is a kind of optical film is usually produced by stacking a light-diffusing layer, a high refractive index layer, a low refractive index layer and the like on a transparent support. The stacking is performed in many cases by applying a transparent metal oxide thin film by a chemical vapor deposition (CVD) method or a physical vapor deposition (PVD) method, particularly by a vacuum vapor deposition method or a sputtering method, which is a kind of physical vapor deposition method, or by a coating method excellent in the productivity.

The antireflection film is used on the outermost surface of a display and therefore, required to satisfy various film strengths, for example, scratch resistance against fine scratching and film hardness high enough to endure the pressure when written with a writing tool.

In order to meet these requirements, a method of setting the thickness of the film by using a poly-functional acrylate compound within the predetermined range (JP-A-7-104109), a method of stacking a hard layer on the surface and a method of incorporating an organosilane compound or incorporating a hydrolysate of an organosilane compound and/or a dehydration condensate thereof previously formed through a reaction using an acid catalyst or a metal chelate catalyst into a coating composition have been performed, but these techniques are insufficient for elevating the hardness of the coating film.

As a result of intensive investigations, the present inventors have found that when the thickness of the optical functional layer, the particle diameter of the resin particle contained therein and the surface optical property are set to respective specific ranges, a necessary optical performance can be stably obtained while keeping high film hardness.

### SUMMARY OF THE INVENTION

An object of the present invention is to provide an optical film having a high film strength and at the same time, stably exhibiting a necessary optical performance. Another object of the present invention is to provide a polarizing plate and a display device each using such an optical film.

According to the present invention, these objects are attained by providing an optical film having the following constructions where the thickness of the light-diffusing layer is increased, a large-size resin particle fitted to this film thickness is used and the surface haze falls within a specified range, and providing a polarizing plate and an image display device.

(1) An optical film comprising: a transparent support; and a light-diffusing layer comprising a first light-transparent resin particle and a binder, wherein the first light-transparent resin particle has an average particle diameter of from 5 to 15 μm, the light-diffusing layer has a film thickness of from 8 to 30 μm, and a haze of a surface, on the side coated with the light-diffusing layer, of the optical film is from 0 to 10%.

(2) The optical film as described in item 1, wherein the light-diffusing layer has a film thickness of 8 to 18 μm.

(3) The optical film as described in item 1 or 2, which has an image sharpness of 30 to 95% as measured with an optical comb width of 0.5 mm.

(4) The optical film as described in any one of items 1 to 3, wherein the light-diffusing layer comprises, as the binder, an epoxy-based resin having two or more epoxy groups within one molecule in an amount of 20 to 100 mass % based on all binders.

(5) The optical film as described in any one of items 1 to 4, wherein the difference between refractive index of the first light-transparent resin particle and refractive index of the binder is from 0.02 to 0.3.

(6) The optical film as described in any one of items 1 to 5, wherein the light-diffusing layer further comprises a second light-transparent resin particle having a refractive index difference of less than 0.02 from refractive index of the binder.

(7) The optical film as described in item 6, wherein the second light-transparent resin particle is contained in an amount of 20 to 70 mass % based on all binders in the light-diffusing layer.

(8) The optical film as described in any one of items 1 to 7, wherein the light-diffusing layer is formed by coating and curing a coating composition for the light-diffusing layer, the coating composition comprising a high-molecular weight compound selected from cellulose esters, acrylic acid esters, urethane acrylates and polystyrene in an amount of 10 to 60 mass % based on all binders.

(9) The optical film as described in any one of items 1 to 8, wherein the light-diffusing layer is formed by coating and curing a coating composition for the light-diffusing layer, the coating composition comprising an organosilicon compound represented by formula (2) or a polymer thereof:

Formula (2):
R²ₘSi(OR¹)₄₋ₘ
(wherein R¹ and R², which may be the same or different, each represents a substituted or unsubstituted alkyl group, and m is 0 or 1).

(10) The optical film as described in any one of items 1 to 9, wherein the light-diffusing layer comprises an inorganic filler comprising a metal oxide.

(11) The optical film as described in any one of items 1 to 10, wherein a surface contact angle, on the side coated with said light-diffusing layer, of the optical film is 90° or more.

(12) An antireflection film which is the optical film as described in any one of items 1 to 11, further comprising a low refractive index layer having a refractive index layer lower than that of the support, so that the transparent support, the light-diffusing layer and the low refractive index layer are arranged in this order.

(13) The antireflection film as described in item 12, wherein the low refractive index layer comprises a fluorine-containing resin formed by heat curing.

(14) The optical film as described in item 12 or 13, wherein the low refractive index layer comprises an inorganic fine particle having a cavity.

(15) The optical film or antireflection film as described in any one of items 1 to 14, wherein any one layer in the optical film or the low refractive index layer is formed by coating and curing a coating solution containing an organosilane compound represented by formula (1), its hydrolysate and/or a partial condensate thereof: 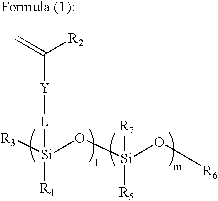
(wherein R₂ represents a hydrogen atom, a methyl group, a methoxy group, an alkoxycarbonyl group, a cyano group, a fluorine atom or a chlorine atom, Y represents a single bond, *—COO—**, *—CONH—** or *—O—**, L represents a divalent linking chain, 1 represents a number satisfying the mathematical formula: 1=100−m, m represents a number of 0 to 50, R₃ to R₅ each independently represents a halogen atom, a hydroxyl group, an unsubstituted alkoxy group or an unsubstituted alkyl group, R₆ represents a hydrogen atom or an alkyl group, and R₇ represents a substituted or unsubstituted alkyl group, a substituted or unsubstituted aryl group or a hydroxyl group).

(16) A polarizing plate comprising: a polarizing layer; and two protective films for the polarizing layer, wherein at least one of the two protective films is the optical film or antireflection film described in items 1 to 15.

(17) A display device comprising the optical film or antireflection film described in items 1 to 15 or the polarizing plate described in item 16, wherein the light-diffusing layer or the low refractive index layer is disposed to come to a viewing side of the display device.

### DETAILED DESCRIPTION OF THE INVENTION

The optical film of the present invention has at least a light-diffusing layer on a transparent support. In the light-diffusing layer, a light-transparent resin particle is dispersed. The light-diffusing layer may be a light-diffusing layer having an antiglare property or a light-diffusing layer having no antiglare property and may comprise one layer or a plurality of layers, for example, from 2 to 4 layers. The refractive index of the material in the portion except for the light-transparent resin particle is preferably from 1.50 to 2.00.

In the optical film of the present invention, a functional layer other than the light-diffusing layer may be provided by coating, and examples of such a layer include a hardcoat layer, an antistatic layer, a low refractive layer and an antifouling layer. The antistatic layer preferably contains an electrically conducting inorganic fine particle. The refractive index of the low refractive index layer is preferably from 1.20 to 1.49, and the low refractive index layer is preferably provided on the outer side of and adjacently to the light-diffusing layer and may be an outermost layer. The optical film may further have an antifouling layer on the low refractive index layer.

The most preferred embodiment of the present invention is an optical film comprising a support having thereon a single-layer light-diffusing layer, or a form having a single-layer low refractive index layer on an optical film comprising a support having thereon a single-layer light-diffusing layer.

Furthermore, in view of reducing the reflectance, the low refractive index layer preferably satisfies the following mathematical formula (I):

Mathematical formula (I):
(mλ/4)×0.7<n₁d₁<(mλ/4)×1.3
wherein m is a positive odd number, n₁ is a refractive index of the low refractive index layer, d₁ is a film thickness (nm) of the low refractive index layer, and λ is a wavelength and a value in the range of 500 to 550 nm.

When mathematical formula (I) is satisfied, this means that m (a positive odd number; usually 1) satisfying mathematical formula (I) is present in the above-described wavelength range.

The optical film of the present invention preferably has internal scattering property. The internal scattering property is generally expressed by an internal haze, and the internal haze is usually a portion obtained by removing the surface haze portion from the entire haze measured. When the antireflection film having an internal scattering property of the present invention is disposed on the outermost surface of a display device, optical unevenness attributable to other constituent elements of the display device (for example, brightness unevenness of the light source or chromaticity unevenness of the color filter) can be reduced and this is preferred. However, an excessively high internal haze incurs reduction of contrast. Therefore, the internal haze is preferably from 1 to 60%, more preferably from 1 to 50%, still more preferably from 1 to 40%.

Also, the surface haze of the optical film of the present invention is preferably from 0 to 10% in the light of enhancing the black reproduction, more preferably from 0.1 to 7%, still more preferably from 0.3 to 5%. The surface haze as used in the present invention is a value obtained by individually determining the entire haze and the internal haze and subtracting the internal haze from the entire haze by calculation.

The image sharpness measured with an optical comb width of 0.5 mm of the optical film of the present invention is preferably from 30 to 95%, and in the light of achieving both the antiglare property and the black reproduction, more preferably from 40 to 80%.

In the present invention, a coating composition is sometimes referred to as a coating solution, but these have the same meaning.

[Light-Diffusing Layer]

The light-diffusing layer according to the present invention is a layer having an effect on the optical performance, and the coating composition therefor comprises a light-transparent resin particle having an average particle diameter of 5 to 15 μm, monomers for the matrix-forming binder, and an organic solvent.

More specifically, the coating composition for forming the light-diffusing layer comprises monomers for the main matrix-forming binder working out to the raw material of a light-transparent polymer which is formed through curing using ionizing radiation or the like, and a light-transparent resin particle having the above-described specific particle diameter, and preferably further contains a resin particle (other than the above-described light-transparent resin particle) having a refractive index close to that of the binder so as to prevent curing, a high-molecular compound, an additive for increasing the film hardness, an inorganic filler for reducing the curling, adjusting the refractive index or other purposes, a coating aid and the like.

The thickness of the light-diffusing layer is usually from 8 to 30 μm, preferably from 8 to 18 μm, more preferably from 10 to 16 μm, most preferably from 12 to 14 μm. When the thickness is in this range, excellent film hardness is obtained, defects such as curling, haze value and glaring are not generated, and the antiglare property, black reproduction and the like can be easily adjusted.

[Main Binder]

The main matrix-forming binder (hereinafter sometimes simply referred to as a “binder”) constituting the light-diffusing layer is preferably a light-transparent polymer having a saturated hydrocarbon chain or a polyether chain as the main chain after curing by ionizing radiation or the like. Also, the main binder polymer after curing preferably has a crosslinked structure.

The binder polymer having a saturated hydrocarbon chain as the main chain after curing is preferably an ethylenically unsaturated monomer or a polymer thereof (first group compound), and the polymer having a polyether chain as the main chain is preferably an epoxy-based monomer or a polymer obtained by ring-opening the epoxy-based monomer (second group compound). Furthermore, a polymer of a mixture of such monomers is also preferred. These compounds are described in detail below.

<First Group Compound>

The binder polymer having a saturated hydrocarbon chain as the main chain and having a crosslinked structure is preferably a (co)polymer of a monomer having two or more ethylenically unsaturated groups.

In order to obtain a high refractive index, the monomer preferably contains in the structure thereof an aromatic ring or at least one atom selected from a halogen atom (excluding fluorine), a sulfur atom, a phosphorus atom and a nitrogen atom.

Examples of the monomer having two or more ethylenically unsaturated groups, which is used in the binder polymer for forming the light-diffusing layer, include an ester of a polyhydric alcohol and a (meth)acrylic acid {for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate and polyester polyacrylate}; a vinylbenzene and a derivative thereof (for example, 1,4-divinylbenzene, 2-acryloylethyl 4-vinylbenzoate and 1,4-divinylcyclohexanone); a vinylsulfone (e.g., divinylsulfone); and a (meth)acrylamide (e.g., methylenebisacrylamide).

Other examples include a resin having two or more ethylenically unsaturated groups, such as relatively low molecular weight polyester resin, polyether resin, acrylic resin, epoxy resin, urethane resin, alkyd resin, spiroacetal resin, polybutadiene resin and polythiolpolyene resin; and an oligomer or prepolymer of a polyfunctional compound (e.g., polyhydric alcohol). These monomers may be used in combination of two or more species thereof. Also, the resin having two or more ethylenically unsaturated groups is preferably contained in an amount of 10 to 70 mass % based on the entire binder amount.

The polymerization of such a monomer having ethylenically unsaturated groups may be performed by ionizing radiation irradiation or heating in the presence of a photoradical polymerization initiator or a thermal radical polymerization initiator. Accordingly, the light-diffusing layer is formed by preparing a coating solution containing a monomer having ethylenically unsaturated groups, a photoradical polymerization initiator or thermal radical polymerization initiator and a resin particle and, if desired further containing an inorganic filler, a coating aid, other additives and at least two kinds of organic solvents, applying the coating solution to a transparent support, and curing the coating solution through a polymerization reaction caused by the effect of ionizing radiation or heat. It is also preferred to perform the curing by ionizing radiation and the heat curing in combination. As for the photopolymerization or thermal polymerization initiator, a commercially available compound may be used, and examples thereof include those described in Saishin UV Koka Gijutsu (Latest UV Curing Technology), page 159, Kazuhiro Takausu (publisher), Gijutsu Joho Kyokai (publishing company) (1991), and the catalogue of Ciba specialty Chemicals.

<Second Group Compound>

In order to reduce the cure shrinkage of the cured film, an epoxy-based compound described below is preferably used. As for such monomers having an epoxy group, a monomer having two or more epoxy groups within one molecule is preferred, and examples thereof include the epoxy-based monomers described in JP-A-2004-264563, JP-A-2004-264564, JP-A-2005-37737, JP-A-2005-37738, JP-A-2005-140862, JP-A-2005-140862, JP-A-2005-140863 and JP-A-2002-322430.

The monomer having an epoxy group is preferably contained in an amount of 20 to 100 mass % for reducing the cure shrinkage, more preferably from 35 to 100 mass %, still more preferably from 50 to 100 mass %, based on all binders constituting the light-diffusing layer.

The second group compound is used particularly preferably when the thickness of the light-diffusing layer is from 15 to 30 μm.

Examples of the photoacid generator capable of generating a cation under the action of light, which is used for polymerizing the epoxy-based monomer or compound, include an ionic compound (e.g., triarylsulfonium salt, diaryliodonium salt) and a nonionic compound (e.g., nitrobenzyl ester of sulfonic acid), and various known photoacid generators such as compounds described in Imaging Yo Yuki Zairyo (Organic Materials for Imaging), The Japanese Research Association for Organic Electronics Materials (compiler), Bunshin Shuppan (1997), may be used. Among these, a sulfonium salt and an iodonium salt are preferred. As for the counter ion, PF₆⁻—, SbF₆⁻—, AsF₆⁻—, B(C₆F₅)₄⁻ and the like are preferred.

Such a polymerization initiator is preferably used in an amount of, in terms of the total polymerization initiator amount, from 0.1 to 15 parts by mass, more preferably from 1 to 10 parts by mass, per 100 parts by mass of the polyfunctional monomers.

It is also preferred to use the first group compound and the second group compound in combination with a high-molecular compound described below.

<Other Preferable Binder Components>

With respect to the binder polymer used in the light-diffusing layer, urethane acrylate-based compounds and an isocyanuric acid acrylate compound are mentioned as additional preferable binder components other than the aforementioned binder. As the urethane acrylate-based compound, any of urethane acrylate monomers, oligomers and polymers may be used. The isocyanuric acid acrylate compound is preferable from the viewpoint of curling reduction.

The molecular weight of the isocyanuric acid acrylate compound is preferably from 300 to 100,000, and more preferably from 400 to 50,000.

As the urethane acrylate-based compound, for example, those obtained by reacting a hydroxyl group-containing compound such as an alcohol, a polyol and/or a hydroxyl group-containing acrylate with an isocyanurate compound, or those obtained by esterifying the polyurethane compound resulting from these reactions with (meth)acrylic acid, according to need, can be mentioned.

Specific examples of the urethane acrylate-based compound include SHIKO UV-1400B, SHIKO UV-1700B, SHIKO UV-6300B, SHIKO UV-7550B, SHIKO UV-7600B, SHIKO UV-7605B, SHIKO UV-7610B, SHIKO UV-7620B, SHIKO UV-7630B, SHIKO UV-7640B, SHIKO UV-6630B, SHIKO UV-7000B, SHIKO UV-7510B, SHIKO UV-7461TE, SHIKO UV-3000B, SHIKO UV-3200B, SHIKO UV-3210EA, SHIKO UV-3310EA, SHIKO UV-3310B, SHIKO UV-3500BA, SHIKO UV-3520TL, SHIKO UV-3700B, SHIKO UV-6100B, SHIKO UV-6640B, SHIKO UV-2000B, SHIKO UV-2010B, SHIKO UV-2250EA, and SHIKO UV-2750B (all being products of the Nippon Synthetic Chemical Industry Co., Ltd.), UL-503LN (a product of Kyoeisha Chemical Co., Ltd.), Unidic 17-806, Unidic 17-813, Unidic V-4030 and Unidic V-4000BA (all being products of Dainippon Ink and Chemicals, Inc.), EB-1290K (a product of Daicel UCB, Ltd.), and Hicope AU-2010 and Hicope AU-2020 (products of Tokushiki Co., Ltd.).

The molecular weight of the urethane acrylate-based compound is preferably from 3000 to 1,000,000, and more preferably from 4000 to 500,000.

The urethane acrylate-based compound is preferably incorporated in 5 to 60% by mass, more preferably in 10 to 50% by mass, and still more preferably in 20 to 40% by mass to the total binder quantity of the light-diffusing layer to which the compound is incorporated.

As the isocyanuric acid acrylate compound, isocyanuric acid diacrylates, isocyanuric acid triacrylates are mentioned, which are more preferably methoxy-, ethoxy-, propoxy- and butoxy-modified. The isocyanuric acid ethoxy-modified diacrylate represented by the following formula (1) is still more preferred as for the aforementioned properties.

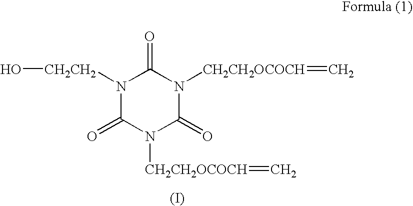

A preferable content of the isocyanuric acid acrylate compound is similar to the preferable content of the aforementioned urethane acrylate compounds.

These and other preferable binder components are used particularly preferably when the thickness of the light-diffusing layer is from IS to 30 μm.

[High-Molecular Compound]

The light-diffusing layer according to the present invention may comprise a high-molecular compound. The addition of a high-molecular compound is advantageous in that the cure shrinkage can be reduced, the adjustment of the coating solution viscosity affecting the dispersion stability (aggregating property) of the resin particle can be more preferentially performed, the polarity of the solid matter in the drying process can be controlled to vary the aggregation behavior of the resin particle, or the drying unevenness in the drying process can be decreased.

The high-molecular compound has already formed a polymer when added to a coating solution. Examples of the high-molecular compound which is preferably used include a resin such as cellulose esters (e.g., cellulose triacetate, cellulose diacetate, cellulose propionate, cellulose acetate propionate, cellulose acetate butyrate, cellulose nitrate), urethane acrylates, polyester acrylates, (meth)acrylic esters (for example, a methyl methacrylate/methyl (meth)acrylate copolymer, a methyl methacrylate/ethyl (meth)acrylate copolymer, a methyl methacrylate/butyl (meth)acrylate copolymer, a methyl methacrylate/styrene copolymer, a methyl methacrylate/(meth)acrylic acid copolymer and a polymethyl methacrylate), and polystyrene.

In view of the effect on the cure shrinkage or the effect of increasing the coating solution viscosity, the high-molecular compound is preferably used in an amount of 10 to 60 mass %, more preferably from 20 to 50 mass %, based on all binders constituting the layer in which the high-molecular compound is contained.

The molecular weight of the high-molecular compound is, in terms of the mass average molecular weight, preferably from 3,000 to 400,000, more preferably from 5,000 to 300,000, still more preferably from 5,000 to 200,000.

The refractive index of the binder is, in terms of the refractive index of the entire matrix, preferably from 1.40 to 2.00, more preferably from 1.45 to 1.90, still more preferably from 1.48 to 1.85, yet still more preferably from 1.51 to 1.80. The refractive index of the binder is a value measured after removing the resin particle from the components of the light-diffusing layer. The refractive index is measured by an Abbe refractometer produced by ATAGO CO., LTD

The binder for the light-diffusing layer is preferably added in an amount of 20 to 95 mass % based on the solid content in the coating solution for the layer.

The light-diffusing layer is preferably formed by applying the coating solution on a support, and performing light irradiation, electron beam irradiation, heat treatment or the like, thereby causing a crosslinking or polymerization reaction. In the case of ultraviolet irradiation, for example, an ultraviolet ray emitted from a light source such as ultrahigh-pressure mercury lamp, high-pressure mercury lamp, low-pressure mercury lamp, carbon arc, xenon arc or metal halide lamp may be utilized.

The curing by the use of an ultraviolet ray is preferably performed with an oxygen concentration reduced by nitrogen purging or the like to 4 vol % or less, more preferably 2 vol % or less, and most preferably 0.5 vol % or less.

[Light-Transparent Resin Particle]

The light-diffusing layer for use in the present invention contains a light-transparent resin particle having an average particle diameter of 5 to 15 μm (hereinafter, referred to as a “first light-transparent resin particle”). The particle diameter of the first light-transparent resin is preferably from 6 to 13 μm, more preferably from 7 to 10 μm. This light-transparent resin particle is used for the purpose of diffusing and thereby weakening the outside light reflected on the display surface or enlarging the viewing angle (particularly the viewing angle in the down direction) to ensure that even when the viewing angle in the observation direction is changed, contrast reduction, black-and-white reversal or color phase change less occurs. In the present invention, when the average particle diameter is within the above-described range, a screen assured of black reproduction and less roughened texture despite appropriate antiglare property can be obtained and on viewing a high-definition display, fine brightness unevenness called glaring ascribable to surface irregularities can be reduced.

In the present invention, for the purpose of controlling the film strength and uniformity of the light-scattering layer having a large film thickness, a second light-transparent resin particle is preferably used in combination with the first light-transparent resin particle. The first light-transparent resin particle and the second light-transparent resin particle are described below.

The first light-transparent resin particle should have the above-described average particle diameter and additionally, the difference in the refractive index from the binder described above needs to be adjusted so as to bring out the light-diffusing effect and the antiglare property. More specifically, the difference in the refractive index between the first light-transparent resin particle and the binder is preferably 0.02 to 0.3, more preferably from 0.03 to 0.25, still more preferably from 0.04 to 0.2.

The second light-transparent resin particle is a particle having a refractive index difference of less than 0.02 from the binder and by virtue of this resin particle, increase in the internal scattering of the light-scattering layer can be suppressed. The difference in the refractive index from the binder is preferably 0.015 or less, more preferably 0.01 or less.

The average particle diameter of the second light-transparent resin layer is preferably from 0.01 to 5 μm, more preferably from 0.1 to 4 μm. Furthermore, a particle having a high crosslinking degree is preferred, and the particle is preferably crosslinked by using a crosslinking agent in an amount of 3 mol % or more based on all monomers before synthesizing the particle.

In the entire solid content of the light-diffusing layer, the amount added of the first light-transparent resin particle is preferably from 2 to 40 mass %, more preferably from 4 to 25 mass %, based on the binder.

The amount added of the second light-transparent resin particle can be adjusted depending on the purpose and is preferably selected from the range of 20 to 70 mass %, and more preferably the range of 30 to 60 mass % based on the binder,

The coated amount of the first light-transparent resin particle is preferably from 10 to 10,000 mg/m², more preferably from 50 to 4,000 mg/m².

The first light-transparent resin particle and the second light-transparent resin particle may be selected from the resin particles described below according to the desired refractive index and average particle size.

Specific preferred examples of the resin particle for use in the present invention include a resin particle such as crosslinked polymethyl methacrylate particle, crosslinked methyl methacrylate-styrene copolymer particle, crosslinked polystyrene particle, crosslinked methyl methacrylate-methyl acrylate copolymer particle and crosslinked acrylate-styrene copolymer particle. Furthermore, a so-called surface-modified particle obtained by chemically bonding a compound containing a fluorine atom, a silicon atom, a carboxyl group, a hydroxyl group, an amino group, a sulfonic acid group, a phosphoric acid group or the like, onto the surface of such a resin particle may also be preferably used. Among these, preferred are a crosslinked styrene particle, a crosslinked polymethyl methacrylate particle and a crosslinked methyl methacrylate-styrene copolymer particle.

The shape of the resin particle may be either true spherical or amorphous. As for the particle size distribution, in view of the control of haze value and diffusion and the homogeneity of coated surface state, a monodisperse particle is preferred. For example, when a particle having a particle diameter 20% or more larger than the average particle diameter is defined as a coarse particle, the percentage of this coarse particle in all particles is preferably 1% or less, more preferably 0.1% or less, still more preferably 0.01% or less. The particle having such a particle diameter distribution is obtained by performing classification after a normal synthesis reaction, and when the number of classifications is increased or the level of classification is elevated, a particle having a more preferred distribution can be obtained.

The particle size distribution of the particle is measured by a Coulter counter method, and the measured distribution is converted into a particle number distribution. The average particle diameter is calculated from the obtained particle distribution.

In the light-diffusing layer for use in the present invention, in addition to these first and second light-transparent resin particles, an “inorganic filler” described later may also be used for the purpose of adjusting the refractive index or film strength.

[Organic Solvent]

The coating composition for forming the light-diffusing layer contains at least one organic solvent.

Examples of the organic solvent include, as the alcohol type, methanol, ethanol, n-propanol, isopropanol, n-butanol, isobutanol, secondary butanol, tertiary butanol, isoamyl alcohol, 1-pentanol, n-hexanol, methyl amyl alcohol; as the ketone type, methyl isobutyl ketone, methyl ethyl ketone, diethyl ketone, acetone, cyclohexanone and diacetone alcohol; as the ester type, methyl acetate, ethyl acetate, n-propyl acetate, isopropyl acetate, isobutyl acetate, n-butyl acetate, isoamyl acetate, n-amyl acetate, methyl propionate, ethyl propionate, methyl butyrate, ethyl butyrate, methyl acetate, methyl lactate and ethyl lactate; as the ether or acetal type, 1,4-dioxane, tetrahydrofuran, 2-methylfuran, tetrahydropyrane and diethylacetal; as the hydrocarbon type, hexane, heptane, octane, isooctane, ligroin, cyclohexane, methylcyclohexane, toluene, xylene, ethylbenzene, styrene and divinylbenzene; as the hydrocarbon halide type, carbon tetrachloride, chloroform, methylene chloride, ethylene chloride, 1,1,1-trichloroethane, 1,1,2-trichloroethane, trichloroethylene, tetrachloroethylene and 1,1,1,2-tetrachloroethane; as the polyhydric alcohol or its derivative type, ethylene glycol, ethylene glycol monomethyl ether, ethylene glycol monoethyl ether, ethylene glycol monoacetate, diethylene glycol, propylene glycol, dipropylene glycol, butanediol, hexylene glycol, 1,5-pentadiol, glycerin monoacetate, glycerin ethers and 1,2,6-hexanetriol; as the fatty acid type, fumaric acid, acetic acid, propionic acid, butyric acid, isobutyric acid, isovaleric acid and lactic acid; as the nitrogen compound type, formamide, N,N-dimethylformamide, acetamide and acetonitrile; and as the sulfur compound type, dimethylsulfoxide.

Among these, preferred are methyl isobutyl ketone, methyl ethyl ketone, cyclohexanone, acetone, toluene, xylene, ethyl acetate and 1-pentanol. Also, for the purpose of controlling the aggregation, an alcohol or polyhydric alcohol-based solvent may be appropriately mixed.

These organic solvents may be used individually or as a mixture, and the organic solvent content is, in terms of the total organic solvent amount in the coating composition, preferably from 40 to 98 mass %, more preferably from 60 to 97 mass %, and most preferably from 70 to 95 mass %.

[Organic Silicon Compound]

The light-diffusing layer of the present invention preferably contains an organic silicon compound represented by the following formula (2) or a polymerization reaction product thereof so as to reduce the cure shrinkage and increase the film hardness.

Formula (2):
R²ₘSi(OR¹)₄₋ₘ
(wherein R¹ and R², which may be the same or different, each represents a substituted or unsubstituted alkyl group, and m is 0 or 1). For example, the examples of the substituent include a methyl group, an ethyl group, a propyl group, or an amyl group and preferably include a methyl group, an ethyl group and a propyl group.

Specific examples of the organic silicon compound represented by formula (2) include the followings:

Si(OCH₃)₄, Si(OC₂H₅)₄, Si(OC₃H₇)₄, Si(OCH(CH₃)₂)₄, Si(OC₄H₉)₄, CH₃CH₂Si(OCH₃)₃, CH₃(CH₂)₂Si(OCH₃)₃, CH₃(CH₂)₃Si(OCH₃)₃, (CH₃)₂(CH)Si(OCH₃)₃, CH₃Si(OC₂H₅)₃, CH₃CH₂Si(OC₂H₅)₃, CH₃(CH₂)₂Si(OC₂H₅)₃, CF₃CF₂(CH₂)₂Si(OCH₃)₃, CF₃(CF₂)₂(CH₂)₂Si(OCH₃)₃. One of these compounds may be used alone, or two or more species thereof may be used in combination.

The method for producing a polymer by using the organic silicon compound represented by formula (2) is not limited, but in the case of producing the polymer by hydrolysis, the catalyst used therefor is known and examples thereof include hydrochloric acid, oxalic acid, nitric acid, acetic acid, hydrofluoric acid, formic acid, phosphoric acid, oxalic acid, ammonia, aluminum acetonate, dibutyltin laurate, tin octylate compound, methanesulfonic acid, trichloromethanesulfonic acid, para-toluenesulfonic acid and trifluoroacetic acid. One of these catalysts may be used alone, or two or more species thereof may be used in combination.

[Inorganic Filler]

In order to increase the layer hardness, decrease the cure shrinkage and further elevate the refractive index, the light-diffusing layer preferably contains, in addition to those particles, a fine inorganic filler comprising an oxide of at least one metal selected from titanium, zirconium, aluminum, indium, zinc, tin and antimony, and having an average primary particle diameter of generally 0.2 μm or less, preferably 0.1 μm or less, more preferably 0.06 μm or less.

On the contrary, in the light-diffusing layer using a resin particle having a high refractive index, it is also preferred to decrease the refractive index of the binder so as to increase the difference in the refractive index from the particle. The inorganic filler usable for this purpose includes a silica fine particle, a hollow silica particle and the like. The preferred particle diameter is the same as that of the fine particle inorganic filler added for elevating the refractive index.

Specific examples of the inorganic fine filler for use in the light-diffusing layer include TiO₂, ZrO₂, Al₂O₃, In₂O₃, ZnO, SnO₂, Sb₂O₃, ITO (Sn-doped indium oxide) and SiO₂. Among these, TiO₂ and ZrO₂ are preferred from the standpoint of elevating the refractive index. It is also preferred to subject the surface of the inorganic filler to a silane coupling treatment or a titanium coupling treatment. A surface treating agent having a functional group capable of reacting with the binder species on the filler surface is preferably used.

The amount of the inorganic fine filler added is preferably from 10 to 90 mass %, more preferably from 20 to 80 mass %, still more preferably from 30 to 75 mass %, based on the entire mass of the light-diffusing layer.

Incidentally, the inorganic fine filler has a particle diameter sufficiently smaller than the wavelength of light and therefore, causes no scattering, and the dispersion obtained by dispersing the filler in the binder polymer has a property as an optically uniform substance.

[Other Additives]

The light-diffusing layer constituting the optical film of the present invention preferably contains an organosilane compound {a so-called sol component (hereinafter sometimes referred to like this), which is described in detail later in the paragraph of Low Refractive Index Layer} in the coating solution for forming the layer so as to enhance the scratch resistance.

(Surfactant for Light-Diffusing Layer)

Particularly, in order to prevent coating unevenness, drying unevenness, point defect or the like and ensure surface uniformity of the light-diffusing layer of the present invention, the coating composition for the light-diffusing layer preferably contains either a fluorine-containing surfactant or a silicone-containing surfactant or both thereof. A fluorine-containing surfactant is preferably used, because the effect of improving surface failures such as coating unevenness, drying unevenness and point defect of the optical film of the present invention can be brought out with a smaller amount of the surfactant added.

The purpose is to impart suitability for high-speed coating while enhancing the surface uniformity and thereby elevate the productivity.

Preferred examples of the fluorine-containing surfactant include a fluoroaliphatic group-containing copolymer (sometimes simply referred to as a “fluorine-based polymer”). The useful fluorine-based polymer is a copolymer of an acrylic or methacrylic resin comprising a repeating unit corresponding to the monomer of (i) below or comprising repeating units corresponding to the monomers of (i) and (ii) below, with a vinyl-based monomer copolymerizable therewith.
(i) Fluoroaliphatic group-containing monomer represented by the following formula (I)

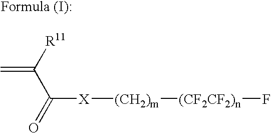

In formula (I), R¹¹ represents a hydrogen atom or a methyl group, X represents an oxygen atom, a sulfur atom, or —N(R¹²)—, m represents an integer of 1 to 6, and n represents an integer of 2 to 4. R¹² represents a hydrogen atom or an alkyl group having a carbon number of 1 to 4 (specifically, a methyl group, an ethyl group, a propyl group or a butyl group), preferably a hydrogen atom or a methyl group. X is preferably an oxygen atom.
(ii) Monomer represented by the following formula (II), which is copolymerizable with monomer of (i)

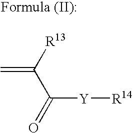

In formula (II), R¹³ represents a hydrogen atom or a methyl group, and Y represents an oxygen atom, a sulfur atom or —N(R¹⁵)—. R¹⁵ represents a hydrogen atom or alkyl group having a carbon number of 1 to 4 (specifically, a methyl group, an ethyl group, a propyl group or a butyl group), preferably a hydrogen atom or a methyl group. Y is preferably an oxygen atom, —N(H)— or —N(CH₃)—.

R¹⁴ represents a linear, branched or cyclic alkyl group having a carbon number of 4 to 20, which may have a substituent, or an alkyl group containing a poly(alkyleneoxy) group.

Examples of the substituent for the alkyl group of R¹⁴ include, but are not limited to, a hydroxy group, an alkylcarbonyl group, an arylcarbonyl group, a carboxyl group, an alkyl ether group, an aryl ether group, a halogen atom (e.g., fluorine, chlorine, bromine), a nitro group, a cyano group and an amino group. Suitable examples of the linear, branched or cyclic alkyl group having a carbon number of 4 to 20 include a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group and an eicosanyl group, which may be linear or branched, and further include a monocyclic cycloalkyl group such as cyclohexyl group and cycloheptyl group, and a polycyclic cycloalkyl group such as bicycloheptyl group, bicyclodecyl group, tricycloundecyl group, tetracyclododecyl group, adamantyl group, norbornyl group and tetracyclodecyl group.

The amount of the fluoroaliphatic group-containing monomer represented by formula (I) for use in the fluorine-based polymer used in the light-diffusing layer of the present invention is 10 mol % or more, preferably from 15 to 70 mol %, more preferably 20 to 60 mol %, based on respective monomers of the fluorine-based polymer.

The mass average molecular weight of the fluorine-based polymer is preferably from 3,000 to 100,000, more preferably from 5,000 to 80,000.

Furthermore, the amount added of the fluorine-based polymer for use in the light-diffusing layer of the present invention is preferably from 0.001 to 5 mass %, more preferably from 0.005 to 3 mass %, still more preferably from 0.01 to 1 mass %, based on the coating solution. When the amount of the fluorine-based polymer added is 0.001 mass % or more, a sufficiently high effect can be provided, and when the amount added is 5 mass % or less, the coating film can be satisfactorily dried and good performance (for example, reflectance and scratch resistance) as the coating film can be obtained.

Specific examples of the structure of the fluorine-based polymer comprising a repeating unit corresponding to the fluoroaliphatic group-containing monomer represented by formula (I) are set forth below, but the present invention is not limited thereto. In the formulae, the numeral indicates a molar ratio of each monomer component, and Mw indicates a mass average molecular weight.

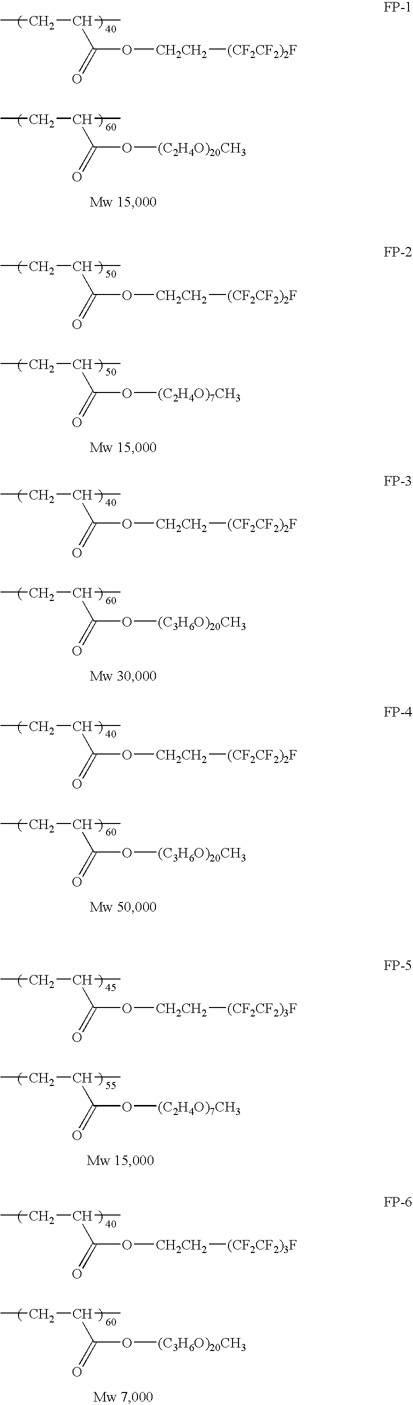

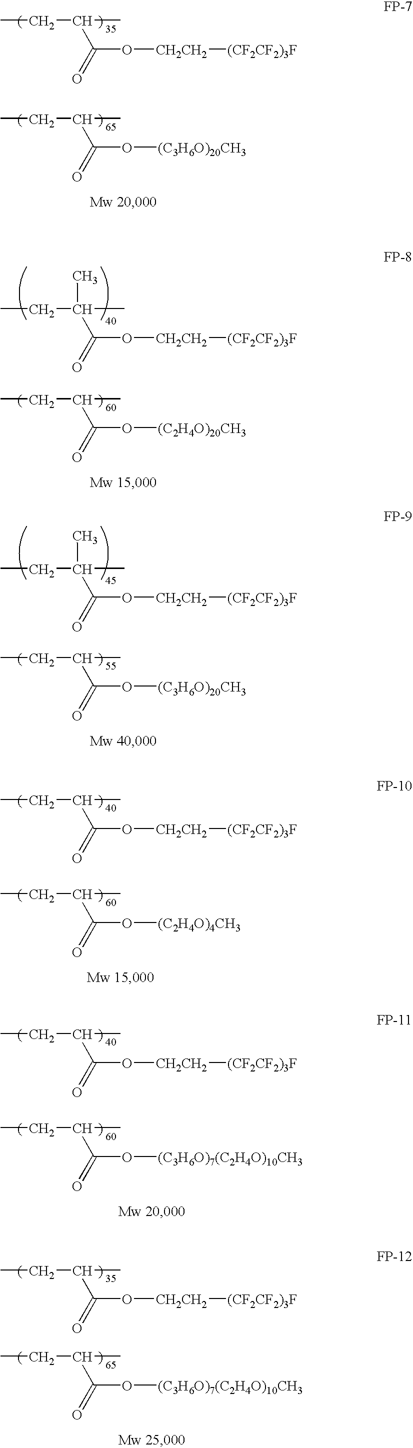

However, use of the fluorine-based polymer described above causes a problem that due to segregation of an F atom-containing functional group on the layer surface, the surface energy of the layer decreases and when a low refractive index layer is overcoated on the light-diffusing layer, the antireflection performance is deteriorated. This is presumed to occur because the wettability of the curable composition used for forming the low refractive index layer is worsened and fine unevenness undetectable with an eye is generated in the low refractive index layer. In order to solve such a problem, it is effective to adjust the structure and amount added of the fluorine-based polymer and thereby control the surface energy of the layer to preferably from 20 to 50 mN·m⁻¹, more preferably from 30 to 40 mN·m⁻¹. For the realization of this surface energy, the F/C which is a ratio of a peak derived from a fluorine atom to a peak derived from a carbon atom as measured by X-ray photoelectron spectroscopy must be from 0.1 to 1.5.

Also, in the case of coating an upper layer, when a fluorine-based polymer capable of being extracted into a solvent used for forming the upper layer is selected, uneven distribution to the lower layer surface (=interface) does not occur and adhesion between the upper layer and the lower layer is ensured, so that even in the high-speed coating, the surface state uniformity can be maintained and an optical film having high scratch resistance can be provided. Furthermore, the purpose can also be achieved by preventing the reduction of the surface free energy and controlling the surface energy of the light-diffusing layer before coating of the low refractive index layer to fall within the above-described range. Examples of such a material include a copolymer of an acrylic or methacrylic resin comprising a repeating unit corresponding to a fluoroaliphatic group-containing monomer represented by the following formula (III), with a vinyl-based monomer copolymerizable therewith.
(iii) Fluoroaliphatic group-containing monomer represented by the following formula (III)

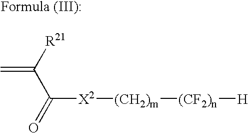

In formula (III), R²¹ represents a hydrogen atom, a halogen atom or a methyl group, preferably a hydrogen atom or a methyl group. X² represents an oxygen atom, a sulfur atom or —N(R²²)—, preferably an oxygen atom or —N(R²²)—, more preferably an oxygen atom. m represents an integer of 1 to 6 (preferably from 1 to 3, more preferably 1), and n represents an integer of 1 to 18 (preferably from 4 to 12, more preferably from 6 to 8). R²² represents a hydrogen atom or an alkyl group having a carbon number of 1 to 8 which may have a substituent, preferably a hydrogen atom or an alkyl group having a carbon number of 1 to 4, more preferably a hydrogen atom or a methyl group.

Also, in the fluorine-based polymer, two or more kinds of the fluoroaliphatic group-containing monomers represented by formula (III) may be contained as constituent components.
(iv) A monomer copolymerizable with the monomer of (iii), represented by the following formula (IV) may also be used.

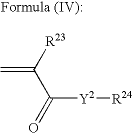

In formula (IV), R²³ represents a hydrogen atom, a halogen atom or a methyl group, preferably a hydrogen atom or a methyl group. Y² represents an oxygen atom, a sulfur atom or —N(R²⁵)—, preferably an oxygen atom or —N(R²⁵)—, more preferably an oxygen atom. R²⁵ represents a hydrogen atom or an alkyl group having a carbon number of 1 to 8, preferably a hydrogen atom or an alkyl group having a carbon number of 1 to 4, more preferably a hydrogen atom or a methyl group.

R²⁴ represents a linear, branched or cyclic alkyl group having a carbon number of 1 to 20 which may have a substituent, an alkyl group containing a poly(alkyleneoxy) group, or an aromatic group (e.g., phenyl, naphthyl) which may have a substituent. R²⁴ is preferably a linear, branched or cyclic alkyl group having a carbon number of 1 to 12 or an aromatic group having a total carbon number of 6 to 18, more preferably a linear, branched or cyclic alkyl group having a carbon number of 1 to 8.

Specific examples of the structure of the fluorine-based polymer containing a repeating unit corresponding to the fluoroaliphatic group-containing monomer represented by formula (III) are set forth below, but the present invention is not limited thereto. In the formulae, the numeral indicates a molar ratio of each monomer component, and Mw indicates a mass average molecular weight.

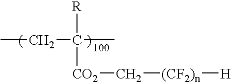

| | R | n | Mw |
|---|---|---|---|
| P-1 | H | 4 | 8000 |
| P-2 | H | 4 | 16000 |
| P-3 | H | 4 | 33000 |
| P-4 | CH₃ | 4 | 12000 |
| P-5 | CH₃ | 4 | 28000 |
| P-6 | H | 6 | 8000 |
| P-7 | H | 6 | 14000 |
| P-8 | H | 6 | 29000 |
| P-9 | CH₃ | 6 | 10000 |
| P-10 | CH₃ | 6 | 21000 |
| P-11 | H | 8 | 4000 |
| P-12 | H | 8 | 16000 |
| P-13 | H | 8 | 31000 |
| P-14 | CH₃ | 8 | 3000 |

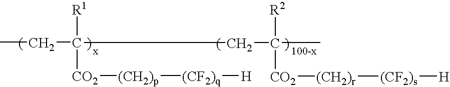

| | x | R¹ | p | q | R² | r | s | Mw |
|---|---|---|---|---|---|---|---|---|
| P-15 | 50 | H | 1 | 4 | CH₃ | 1 | 4 | 10000 |
| P-16 | 40 | H | 1 | 4 | H | 1 | 6 | 14000 |
| P-17 | 60 | H | 1 | 4 | CH₃ | 1 | 6 | 21000 |
| P-18 | 10 | H | 1 | 4 | H | 1 | 8 | 11000 |
| P-19 | 40 | H | 1 | 4 | H | 1 | 8 | 16000 |
| P-20 | 20 | H | 1 | 4 | CH₃ | 1 | 8 | 8000 |
| P-21 | 10 | CH₃ | 1 | 4 | CH₃ | 1 | 8 | 7000 |
| P-22 | 50 | H | 1 | 6 | CH₃ | 1 | 6 | 12000 |
| P-23 | 50 | H | 1 | 6 | CH₃ | 1 | 6 | 22000 |
| P-24 | 30 | H | 1 | 6 | CH₃ | 1 | 6 | 5000 |

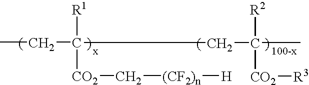

| | x | R¹ | n | R² | R³ | Mw |
|---|---|---|---|---|---|---|
| FP-148 | 80 | H | 4 | CH₃ | CH₃ | 11000 |
| FP-149 | 90 | H | 4 | H | C₄H₉(n) | 7000 |
| FP-150 | 95 | H | 4 | H | C₆H₁₃(n) | 5000 |
| FP-151 | 90 | CH₃ | 4 | H | CH₂CH(C₂H₅)C₄H₉(n) | 15000 |
| FP-152 | 70 | H | 6 | CH₃ | C₂H₅ | 18000 |
| FP-153 | 90 | H | 6 | CH₃ | 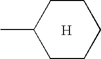 | 12000 |
| FP-154 | 80 | H | 6 | H | C₄H₉(sec) | 9000 |
| FP-155 | 90 | H | 6 | H | C₁₂H₂₅ (n) | 21000 |
| FP-156 | 60 | CH₃ | 6 | H | CH₃ | 15000 |
| FP-157 | 60 | H | 8 | H | CH₃ | 10000 |
| FP-158 | 70 | H | 8 | H | C₂H₅ | 24000 |
| FP-159 | 70 | H | 8 | H | C₄H₉(n) | 5000 |
| FP-160 | 50 | H | 8 | H | C₄H₉(n) | 16000 |
| FP-161 | 80 | H | 8 | CH₃ | C₄H₉(iso) | 13000 |
| FP-162 | 80 | H | 8 | CH₃ | C₄H₉(t) | 9000 |
| FP-163 | 60 | H | 8 | H | 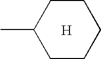 | 7000 |
| FP-164 | 80 | H | 8 | H | CH₂CH(C₂H₅)C₄H₉(n) | 8000 |
| FP-165 | 90 | H | 8 | H | C₁₂H₂₅(n) | 6000 |
| FP-166 | 80 | CH₃ | 8 | CH₃ | C₄H₉(sec) | 18000 |
| FP-167 | 70 | CH₃ | 8 | CH₃ | CH₃ | 22000 |
| FP-168 | 70 | H | 10 | CH₃ | H | 17000 |
| FP-169 | 90 | H | 10 | H | H | 9000 |

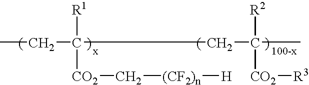

| | x | R¹ | n | R² | R³ | Mw |
|---|---|---|---|---|---|---|
| FP-170 | 95 | H | 4 | CH₃ | —(CH₂CH₂O)₂—H | 18000 |
| FP-171 | 80 | H | 4 | H | —(CH₂CH₂O)₂—CH₃ | 16000 |
| FP-172 | 80 | H | 4 | H | —(C₃H₆O)₇—H | 24000 |
| FP-173 | 70 | CH₃ | 4 | H | —(C₃H₆O)₁₃—H | 18000 |
| FP-174 | 90 | H | 6 | H | —(CH₂CH₂O)₂—H | 21000 |
| FP-175 | 90 | H | 6 | CH₃ | —(CH₂CH₂O)₈—H | 9000 |
| FP-176 | 80 | H | 6 | H | —(CH₂CH₂O)₂—C₄H₉(n) | 12000 |
| FP-177 | 80 | H | 6 | H | —(C₃H₆O)₇—H | 34000 |
| FP-178 | 75 | F | 6 | H | —(C₃H₆O)₁₃—H | 11000 |
| FP-179 | 85 | CH₃ | 6 | CH₃ | —(C₃H₆O)₂₀—H | 18000 |
| FP-180 | 95 | CH₃ | 6 | CH₃ | —CH₂CH₂OH | 27000 |
| FP-181 | 80 | H | 8 | CH₃ | —(CH₂CH₂O)₈—H | 12000 |
| FP-182 | 95 | H | 8 | H | —(CH₂CH₂O)₉—CH₃ | 20000 |
| FP-183 | 90 | H | 8 | H | —(C₃H₆O)₇—H | 8000 |
| FP-184 | 95 | H | 8 | H | —(C₃H₆O)₂₀—H | 15000 |
| FP-185 | 90 | F | 8 | H | —(C₃H₆O)₁₃—H | 12000 |
| FP-186 | 80 | H | 8 | CH₃ | —(CH₂CH₂O)₂—H | 20000 |
| FP-187 | 95 | CH₃ | 8 | H | —(CH₂CH₂O)₉—CH₃ | 17000 |
| FP-188 | 90 | CH₃ | 8 | H | —(C₃H₆O)₇—H | 34000 |
| FP-189 | 80 | H | 10 | H | —(CH₂CH₂O)₃—H | 19000 |
| FP-190 | 90 | H | 10 | H | —(C₃H₆O)₇—H | 8000 |
| FP-191 | 80 | H | 12 | H | —(CH₂CH₂O)₇—CH₃ | 7000 |
| FP-192 | 95 | CH₃ | 12 | H | —(C₃H₆O)₇—H | 10000 |

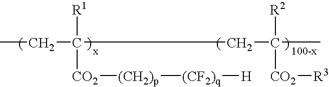

| | x | R¹ | p | q | R² | R³ | Mw |
|---|---|---|---|---|---|---|---|
| FP- | 80 | H | 2 | 4 | H | C₄H₉(n) | 18000 |
| 193 | | | | | | | |
| FP- | 90 | H | 2 | 4 | H | —(CH₂CH₂O)₉—CH₃ | 16000 |
| 194 | | | | | | | |
| FP- | 90 | CH₃ | 2 | 4 | F | C₆H₁₃(n) | 24000 |
| 195 | | | | | | | |
| FP- | 80 | CH₃ | 1 | 6 | F | C₄H₉(n) | 18000 |
| 196 | | | | | | | |
| FP- | 95 | H | 2 | 6 | H | —(C₃H₆O)₇—H | 21000 |
| 197 | | | | | | | |
| FP- | 90 | CH₃ | 3 | 6 | H | —CH₂CH₂OH | 9000 |
| 198 | | | | | | | |
| FP- | 75 | H | 1 | 8 | F | CH₃ | 12000 |
| 199 | | | | | | | |
| FP- | 80 | H | 2 | 8 | H | CH₂CH(C₂H₅)C₄H₉ (n) | 34000 |
| 200 | | | | | | | |
| FP- | 90 | CH₃ | 2 | 8 | H | —(C₃H₆O)₇—H | 11000 |
| 201 | | | | | | | |
| FP- | 80 | H | 3 | 8 | CH₃ | CH₃ | 18000 |
| 202 | | | | | | | |
| FP- | 90 | H | 1 | 10 | F | C₄H₉(n) | 27000 |
| 203 | | | | | | | |
| FP- | 95 | H | 2 | 10 | H | —(CH₂CH₂O)₉—CH₃ | 12000 |
| 204 | | | | | | | |
| FP- | 85 | CH₃ | 2 | 10 | CH₃ | C₄H₉(n) | 20000 |
| 205 | | | | | | | |
| FP- | 80 | H | 1 | 12 | H | C₆H₁₃(n) | 8000 |
| 206 | | | | | | | |
| FP- | 90 | H | 1 | 12 | H | —(C₃H₆O)₁₃—H | 15000 |
| 207 | | | | | | | |
| FP- | 60 | CH₃ | 3 | 12 | CH₃ | C₂H₅ | 12000 |
| 208 | | | | | | | |
| FP- | 60 | H | 1 | 16 | H | CH₂CH(C₂H₅)C₄H₉ (n) | 20000 |
| 209 | | | | | | | |
| FP- | 80 | CH₃ | 1 | 16 | H | —(CH₂CH₂O)₂—C₄H₉(n) | 17000 |
| 210 | | | | | | | |
| FP- | 90 | H | 1 | 18 | H | —CH₂CH₂OH | 34000 |
| 211 | | | | | | | |
| FP- | 60 | H | 3 | 18 | CH₃ | CH₃ | 19000 |
| 212 | | | | | | | |

Furthermore, when the surface energy is prevented from reduction at the time of overcoating the low refractive index layer on the light-diffusing layer, deterioration of the antireflection performance can be prevented. A fluorine-based polymer is used at the coating of the light-diffusing layer to reduce the surface tension of the coating solution so that the surface state uniformity can be increased and the high productivity by high-speed coating can be maintained, and after the coating of the antiglare layer, a surface treatment such as corona treatment, UV treatment, heat treatment, saponification treatment or solvent treatment, preferably a corona treatment, is applied to prevent reduction of the surface free energy so that the surface energy of the light-diffusing layer before coating of the low refractive index layer can be controlled to fall within the above-described range, whereby the purpose can be achieved.

Also, a thixotropy agent may be added to the coating composition for forming the light-diffusing layer of the present invention. Examples of the thixotropy agent include silica and mica each in a size of 0.1 μm or less. Usually, the content of this additive is suitably on the order of 1 to 10 parts by mass per 100 parts by mass of the ultraviolet-curable resin.

The optical film of the present invention preferably has a correlation between the intensity distribution of scattered light as measured by a goniophotometer and the effect of improving the viewing angle. That is, as the light emitted from backlight is more diffused by the effect of internal scattering of the light-transparent fine particles contained in the optical film disposed on the polarizing plate surface on the viewing side, the viewing angle properties are more enhanced. However, if the light is excessively diffused, backward scattering increases and the front brightness decreases. Also, excessively large scattering may cause a problem such as deterioration of image sharpness. Accordingly, the intensity distribution of scattered light needs to be controlled to a certain range. As a result of intensive studies, in order to achieve desired viewing properties, the intensity of scattered light particularly at 30° having a correlation with the effect of improving the viewing angle is preferably from 0.01 to 0.2%, more preferably from 0.02 to 0.15%, still more preferably from 0.03 to 0.1%, based on the intensity of light at an outgoing angle of 0° in the scattered light profile.

The scattered light profile can be obtained by measuring the prepared light-scattering film with use of an automatic goniophotometer, Model GP-5, manufactured by Murakami Color Research Laboratory.

[Low Refractive Index Layer]

In the optical film of the present invention, a low refractive index layer is also preferably stacked on the light-diffusing layer. For example, the low refractive index is preferably a cured film formed by coating a curable composition mainly comprising a fluorine-containing polymer and/or a polyfunctional ionizing radiation-curable monomer, and drying and curing the composition. Also, the curable composition preferably further contains an organosilane compound, its hydrolysate and/or a partial condensate thereof.

The refractive index of the low refractive index layer in the antireflection film of the present invention is preferably from 1.20 to 1.48, more preferably from 1.30 to 1.46.

[Fluorine-Containing Polymer for Low Refractive Index Layer]

In the case of performing the coating and curing while transporting a roll film in the web form, from the standpoint of enhancing the productivity, the fluorine-containing polymer is preferably a polymer capable of giving a cured film in which the coefficient of dynamic friction of the film is from 0.03 to 0.20, the contact angle with water is from 90 to 120° and the slipping angle of pure water is 70° or less, and being crosslinked by the effect of heat or ionizing radiation.

Also, when the optical film of the present invention is loaded on an image display device, the peel force with a commercially available adhesive tape is preferably lower because a seal or memo attached can be easily peeled off, and the peel force is preferably 500 gf (4.9 N) or less, more preferably 300 gf (2.9 N) or less, and most preferably 100 gf (0.98 N) or less. Furthermore, as the surface hardness is higher, scratching is less caused. Therefore, the surface hardness as measured by a microhardness meter is preferably 0.3 GPa or more, more preferably 0.5 GPa or more.

The fluorine-containing polymer for use in the low refractive index layer is preferably a fluorine-containing polymer containing a fluorine atom in the range from 35 to 80 mass % and further containing a crosslinking or polymerizable functional group. Examples thereof include a hydrolysate of a perfluoroalkyl group-containing silane compound [e.g., (heptadecafluoro-1,1,2,2-tetrahydrodecyl)triethoxysilane], a dehydrating condensate thereof, and a fluorine-containing copolymer comprising, as constituent components, a fluorine-containing monomer unit and a crosslinking reactive unit. In the case of a fluorine-containing copolymer, the main chain preferably comprises only a carbon atom. That is, it is preferred that the main chain skeleton does not contain an oxygen atom, a nitrogen atom and the like.

Specific examples of the fluorine-containing monomer unit include fluoroolefins (e.g., fluoroethylene, vinylidene fluoride, tetrafluoroethylene, perfluorooctylethylene, hexafluoropropylene, perfluoro-2,2-dimethyl-1,3-dioxol), partially or completely fluorinated alkyl ester derivatives of (meth)acrylic acid (e.g., BISCOTE 6FM (produced by Osaka Yuki Kagaku), M-2020 (produced by Daikin)), and completely or partially fluorinated vinyl ethers. Among these, perfluoroolefins are preferred and in view of refractive index, solubility, transparency, availability and the like, hexafluoropropylene is more preferred.

Examples of the crosslinking reactive unit include a constituent unit obtained by polymerizing a monomer previously having a self-crosslinking functional group within the molecule, such as glycidyl (meth)acrylate and glycidyl vinyl ether; and a constituent unit obtained by polymerizing a monomer having a carboxyl group, a hydroxyl group, an amino group or the like [a monomer such as (meth)acrylic acid, methylol (meth)acrylate, hydroxyalkyl (meth)acrylate, allyl acrylate, hydroxyethyl vinyl ether, hydroxybutyl vinyl ether, maleic acid and crotonic acid] and introducing into the obtained constituent unit a crosslinking reactive group such as (meth)acryloyl group by a polymer reaction (for example, the crosslinking reactive group can be introduced by causing an acrylic acid chloride to act on a hydroxyl group).

Other than the above-described fluorine-containing monomer unit and crosslinking reactive unit, in view of solubility in a solvent and transparency or the like of the film, another polymerization unit may also be introduced by appropriately copolymerizing a monomer not containing a fluorine atom. The monomer unit which can be used in combination is not particularly limited and examples thereof include olefins [e.g., ethylene, propylene, isoprene, vinyl chloride, vinylidene chloride], acrylic acid esters [e.g., methyl acrylate, methyl acrylate, ethyl acrylate, 2-ethylhexyl acrylate], methacrylic acid esters [e.g., methyl methacrylate, ethyl methacrylate, butyl methacrylate, ethylene, glycol dimethacrylate], styrene derivatives [e.g., styrene, divinylbenzene, vinyltoluene, α-methylstyrene], vinyl ethers [e.g., methyl vinyl ether, ethyl vinyl ether, cyclohexyl vinyl ether], vinyl esters [e.g., vinyl acetate, vinyl propionate, vinyl cinnamate], acrylamides [e.g., N-tert-butylacrylamide, N-cyclohexylacrylamide], methacrylamides and acrylonitrile derivatives.

With such a fluorine-containing polymer, a hardening agent may be appropriately used in combination as described in JP-A-10-25388 and JP-A-10-147739.

The fluorine-containing polymer particularly useful in the present invention is a random copolymer of a perfluoroolefin and a vinyl ether or ester. In particular, the fluorine-containing polymer preferably has a group capable of undergoing a crosslinking reaction by itself [for example, a radical reactive group such as (meth)acryloyl group, or a ring-opening polymerizable group such as epoxy group and oxetanyl group].

The crosslinking reactive group-containing polymerization unit preferably occupies from 5 to 70 mol %, more preferably from 30 to 60 mol %, in all polymerization units of the polymer.

A preferred embodiment of the fluorine-containing polymer for use in the low refractive index layer of the present invention is a copolymer represented by formula 1: Formula 1:

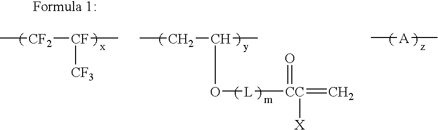

In formula 1, L represents a linking group having a carbon number of 1 to 10, preferably from 1 to 6, more preferably from 2 to 4, which may have a linear, branched or cyclic structure and may contain a heteroatom selected from O, N and S.

Preferred examples thereof include *—(CH₂)₂—O—**, *—(CH₂)₂—NH—**, *—(CH₂)₄—O—**, *—(CH₂)₆—O—**, *—(CH₂)₂—O—(CH₂)₂—**, *—CONH—(CH₂)₃—**, *—CH₂CH(OH)CH₂—O—** and *—CH₂CH₂OCONH(CH₂)₃—O—** (wherein * denotes a linking site on the polymer main chain side and ** denotes a linking site on the (meth)acryloyl group side). m represents 0 or 1.

In formula 1, X represents a hydrogen atom or a methyl group and in view of the curing reactivity, preferably a hydrogen atom.

In formula 1, A represents a repeating unit derived from an arbitrary vinyl monomer. The repeating unit is not particularly limited as long as it is a constituent component of a monomer copolymerizable with hexafluoropropylene, and may be appropriately selected from various viewpoints such as adhesion to the substrate, Tg (contributing to film hardness) of the polymer, solubility in the solvent, transparency, slipperiness and dust-protecting-antifouling property. The repeating unit may comprise a single vinyl monomer or a plurality of vinyl monomers according to the purpose.

Preferred examples of the vinyl monomer include vinyl ethers such as methyl vinyl ether, ethyl vinyl ether, tert-butyl vinyl ether, cyclohexyl vinyl ether, isopropyl vinyl ether, hydroxyethyl vinyl ether, hydroxybutyl vinyl ether, glycidyl vinyl ether and allyl vinyl ether; vinyl esters such as vinyl acetate, vinyl propionate and vinyl butyrate; (meth)acrylates such as methyl (meth)acrylate, ethyl (meth)acrylate, hydroxyethyl (meth)acrylate, glycidyl methacrylate, allyl (meth)acrylate and (meth)acryloyloxypropyltrimethoxysilane; styrene derivatives such as styrene and p-hydroxymethylstyrene; and unsaturated carboxylic acids and derivatives thereof, such as crotonic acid, maleic acid and itaconic acid. Among these, vinyl ether derivatives and vinyl ester derivatives are preferred, and vinyl ether derivatives are more preferred.

x, y and z represent mol % of respective constituent components and are preferably 30≦x≦60, 5≦y≦70 and 0≦z≦65, more preferably 35≦x≦55, 30≦y≦60 and 0≦z≦20, still more preferably 40≦x≦55, 40≦y≦55 and 0≦z≦10, with the proviso that x+y+z=100

A particularly preferred embodiment of the copolymer for use in the present invention is a compound represented by formula 2:

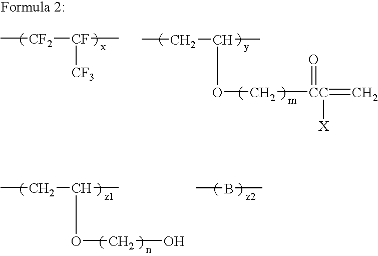

In formula 2, X has the same meaning as in formula 1 and the preferred range is also the same.

n represents an integer of 2≦n≦10, preferably 2≦n≦6, more preferably 2≦n≦4.

B represents a repeating unit derived from an arbitrary vinyl monomer and may comprise a single composition or a plurality of compositions. Examples thereof include those described above as examples of A in formula 1.

x, y, z1 and z2 represent mol % of respective repeating units. x and y preferably satisfy 30≦x≦60 and 5≦y≦70, more preferably 35≦x≦55 and 30≦y≦60, still more preferably 40≦x≦55 and 40≦y≦55, and z1 and z2 preferably satisfy 0≦z1≦65 and 0≦z2≦65, more preferably 0≦z1≦30 and 0≦z2≦10, still more preferably 0≦z1≦10 and 0≦z2≦5, with the proviso that x+y+z1+z2=100.

The copolymer represented by formula 1 or 2 can be synthesized, for example, by introducing a (meth)acryloyl group into a copolymer comprising a hexafluoropropylene component and a hydroxyalkyl vinyl ether component by any method described above. The reprecipitation solvent used here is preferably isopropanol, hexane, methanol or the like.

Specific preferred examples of the copolymers represented by formulae 1 and 2 include those described in JP-A-2004-45462, paragraphs [0035] to [0047], and the copolymers may be synthesized by the method described in this patent publication.

[Organosilane Compound]

The light-diffusing layer or low refractive index layer for use in the present invention is enhanced in the scratch resistance by incorporating an organosilane compound, so-called sol component (hereinafter sometimes referred to like this), into the coating solution for forming the layer. Particularly, when the low refractive index layer and a layer adjacent thereto contain this compound, the antireflection ability and the scratch resistance can be enhanced. This sol component is condensed to form a cured product during drying and heating after the coating of the coating solution and works out to a part of the binder of the layer. In the case where the cured product has a polymerizable unsaturated bond, a binder having a three-dimensional structure is formed by the irradiation with actinic rays.

The organosilane compound is preferably represented by the following formula 3:

Formula 3:
(R¹)ₘ—Si(X)₄₋ₘ

In formula 3, R¹ represents a substituted or unsubstituted alkyl group or a substituted or unsubstituted aryl group. The alkyl group is preferably an alkyl group having a carbon number of 1 to 30, more preferably from 1 to 16, still more preferably from 1 to 6. Specific examples of the alkyl group include methyl, ethyl, propyl, isopropyl, hexyl, decyl and hexadecyl. Examples of the aryl group include phenyl and naphthyl, with a phenyl group being preferred.

X represents a hydroxyl group or a hydrolyzable group, and examples thereof include an alkoxy group (preferably an alkoxy group having a carbon number of 1 to 5, e.g., methoxy, ethoxy), a halogen atom (e.g., Cl, Br, I) and a group represented by R²COO (wherein R² is preferably a hydrogen atom or an alkyl group having a carbon number of 1 to 6, e.g., CH₃COO, C₂H₅COO). Among these, an alkoxy group is preferred, and a methoxy group and an ethoxy group are more preferred. m represents an integer of 1 to 3, preferably 1 or 2.

When a plurality of R¹ and Xs are present, the plurality of R¹ and Xs may be the same or different.

The substituent contained in R¹ is not particularly limited, but examples thereof include a halogen atom (e.g., fluorine, chlorine, bromine), a hydroxyl group, a mercapto group, a carboxyl group, an epoxy group, an alkyl group (e.g., methyl, ethyl, i-propyl, propyl, tert-butyl), an aryl group (e.g., phenyl, naphthyl), an aromatic heterocyclic group (e.g., furyl, pyrazolyl, pyridyl), an alkoxy group (e.g., methoxy, ethoxy, i-propoxy, hexyloxy), an aryloxy group (e.g., phenoxy), an alkylthio group (e.g., methylthio, ethylthio), an arylthio group (e.g., phenylthio), an alkenyl group (e.g., vinyl, 1-propenyl), an acyloxy group (e.g., acetoxy, acryloyloxy, methacryloyloxy), an alkoxycarbonyl group (e.g., methoxycarbonyl, ethoxy-carbonyl), an aryloxycarbonyl group (e.g., phenoxycarbonyl), a carbamoyl group (e.g., carbamoyl, N-methylcarbamoyl, N,N-dimethylcarbamoyl, N-methyl-N-octylcarbamoyl) and an acylamino group (e.g., acetylamino, benzoylamino, acrylamino, methacrylamino). These substituents each may be further substituted.

R¹ is preferably a substituted alkyl group or a substituted aryl group. In particular, an organosilane compound having a vinyl polymerizable substituent, represented by the following formula (1) is preferred.

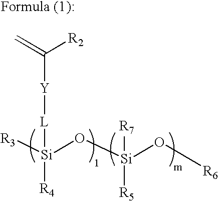

In formula (1), R₂ represents a hydrogen atom, a methyl group, a methoxy group, an alkoxycarbonyl group, a cyano group, a fluorine atom or a chlorine atom. Examples of the alkoxycarbonyl group include a methoxycarbonyl group and an ethoxycarbonyl group. R₂ is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, still more preferably a hydrogen atom or a methyl group.

Y represents a single bond, *—COO—**, *—CONH—** or *—O—**, preferably a single bond, *—COO—** or *—CONH—**, more preferably a single bond or *—COO—**, still more preferably *—COO—**. * denotes the position bonded to ═C(R₂)— and ** denotes the position bonded to L.

L represents a divalent linking chain. Specific examples thereof include a substituted or unsubstituted alkylene group, a substituted or unsubstituted arylene group, a substituted or unsubstituted alkylene group having inside a linking group (e.g., ether, ester, amido), and a substituted or unsubstituted arylene group having inside a linking group. L is preferably a substituted or unsubstituted alkylene group, a substituted or unsubstituted arylene group or an alkylene group having inside a linking group, more preferably an unsubstituted alkylene group, an unsubstituted arylene group or an alkylene group having inside an ether or ester linking group, still more preferably an unsubstituted alkylene group or an alkylene group having inside an ether or ester linking group. Examples of the substituent include a halogen, a hydroxyl group, a mercapto group, a carboxyl group, an epoxy group, an alkyl group and an aryl group. These substituents each may be further substituted.

1 represents a number satisfying the mathematical formula: 1=100−m, and m represents a number of 0 to 50. m is preferably a number of 5 to 40, more preferably a number of 10 to 30.

R₃ to R₅ each is preferably a chlorine atom, a hydroxyl group, an unsubstituted alkyl group or an unsubstituted alkoxy group, more preferably a hydroxyl group or an alkoxy group having a carbon number of 1 to 6, still more preferably a hydroxyl group or an alkoxy group having a carbon number of 1 to 3. R₆ represents a hydrogen atom or an alkyl group. The alkyl group is preferably a methyl group or an ethyl group.

R₇ represents a substituted or unsubstituted alkyl group, a substituted or unsubstituted aryl group or a hydroxyl group, preferably an alkyl group having a carbon number of 1 to 3 or a hydroxyl group.

Specific examples of the starting material for the compound represented by formula (1) are set forth below, but the present invention is not limited thereto.

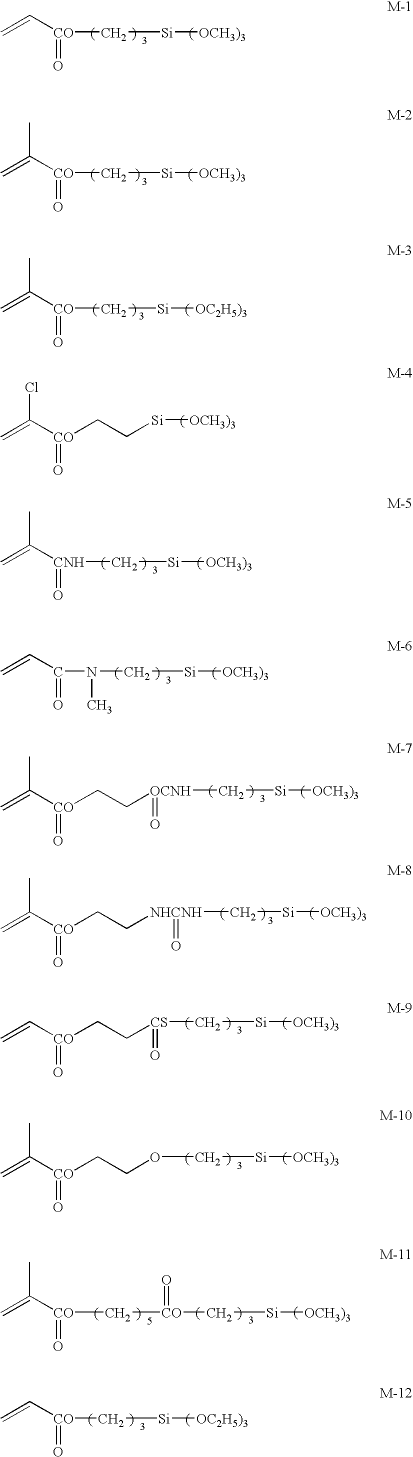

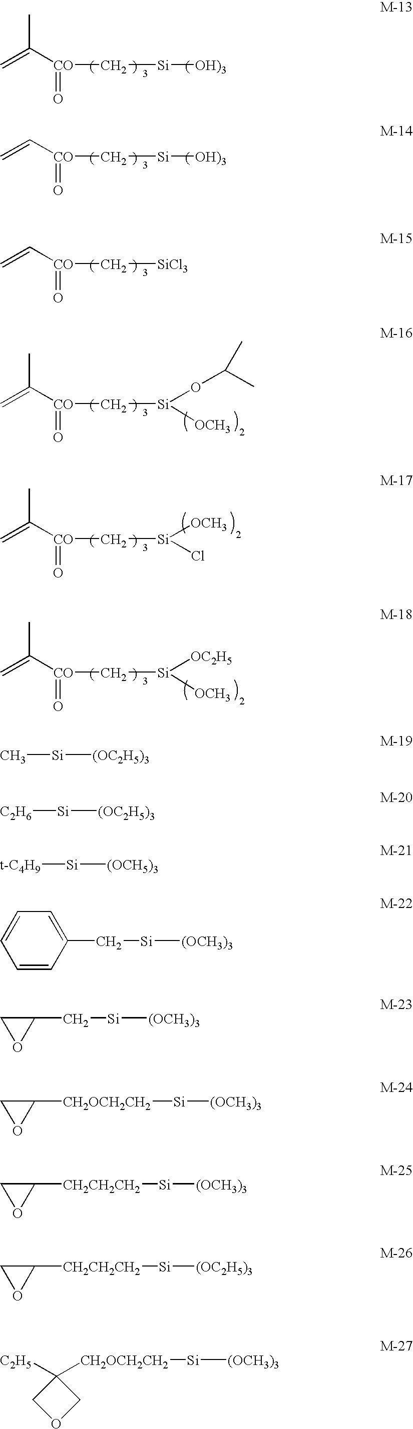

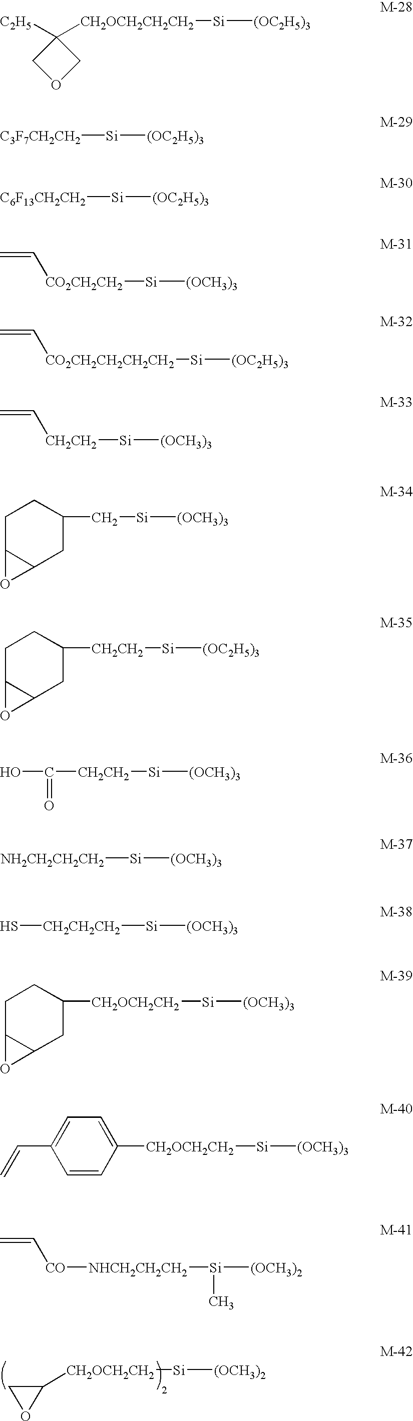

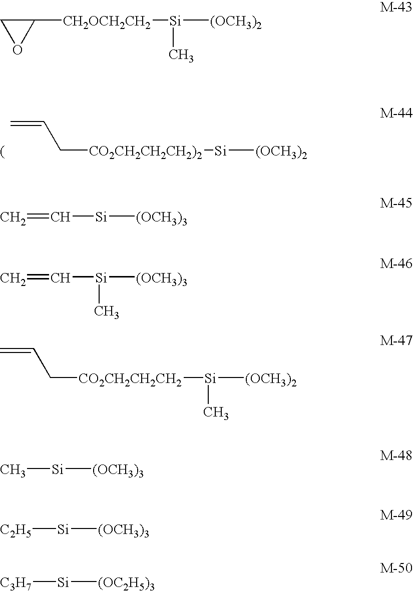

Among these, a combination of organosilanes selected from (M-1), (M-2), (M-25), (M-19), (M-48) and (M-49) is preferred.

In order to obtain the effect of the present invention, the content of the vinyl polymerizable group-containing organosilane in the hydrolysate of organosilane and/or a partial condensate thereof is preferably from 30 to 100 mass %, more preferably from 50 to 100 mass %, still more preferably from 70 to 100 mass %, yet still more preferably from 90 to 100 mass %. When the content of the vinyl polymerizable group-containing organosilane is in the above-described range, this ensures no production of a solid matter, no clouding of the liquid and no worsening of the pot life or there is not caused a problem that when a polymerization treatment is performed, the performance (for example, scratch resistance of the antireflection film) can be hardly enhanced due to difficulty in the control of the molecular weight or a small content of the polymerizable group.

At least either one of the hydrolysate of organosilane of the present invention and a partial condensate thereof preferably has a low volatility so as to stabilize the performance of the coated product. Specifically, the volatilization volume per hour at 105° C. is preferably 5 mass % or less, more preferably 3 mass % or less, still more preferably 1 mass % or less.

The content of the vinyl polymerizable group-containing organosilane in at least either one of the hydrolysate of organosilane of the present invention and a partial condensate thereof (the content of the vinyl polymerizable group-containing organosilane in the organosilane raw material used when synthesizing the organosilane compound represented by formula (1), its hydrolysate and/or a partial condensate thereof) is preferably from 50 to 100 mass %, more preferably from 60 to 95 mass %, still more preferably from 70 to 10 mass %. If the content of the vinyl polymerizable group-containing organosilane is less than 50 mass %, this may cause production of a solid matter, clouding of the liquid or worsening of the pot life or when a polymerization treatment is performed, the performance (for example, scratch resistance of the antireflection film) can be hardly enhanced due to difficulty in the control of the molecular weight (increase in the molecular weight) or a small content of the polymerizable group.

The sol component for use in the present invention is prepared by the hydrolysis and/or partial condensation of the organosilane.

The hydrolysis and condensation reaction is performed by adding water in an amount of 0.05 to 2.0 mol, preferably from 0.1 to 1.0 mol, per mol of the hydrolyzable group (X) and stirring the resulting solution at 25 to 100° C. in the presence of a catalyst for use in the present invention.

In at least either one of the hydrolysate of organosilane of the present invention and a partial condensate thereof, either the hydrolysate of the vinyl polymerizable group-containing organosilane or the partial condensate thereof preferably has a mass average molecular weight of 450 to 20,000, more preferably from 500 to 10,000, still more preferably from 550 to 5,000, yet still more preferably from 600 to 3,000, excluding the components having a molecular weight of less than 300.

Out of the components having a molecular weight of 300 or more in the hydrolysate of organosilane and/or a partial condensate thereof, the content of the components having a molecular weight of more than 20,000 is preferably 10 mass % or less, more preferably 5 mass % or less, still more preferably 3 mass % or less. If this content exceeds 10 mass %, the cured film obtained by curing a curable composition containing such a hydrolysate of organosilane and/or a partial condensate thereof is sometimes poor in transparency or adhesion to the substrate.

Here, the mass average molecular weight and the molecular weight are a molecular weight determined by the differential refractometer detection with a solvent THF in a GPC analyzer using a column, TSKgel GMH×L, TSKgel G4000H×L or TSKgel G2000H×L (trade names, all produced by Tosoh Corp.), and expressed in terms of polystyrene. The content is an area % of the peaks in the above-described molecular weight range, assuming that the peak area of the components having a molecular weight of 300 or more is 100%.

The dispersity (mass average molecular weight/number average molecular weight) is preferably from 3.0 to 1.1, more preferably from 2.5 to 1.1, still more preferably from 2.0 to 1.1, yet still more preferably from 1.5 to 1.1.

The condensed state of X in formula 1 in the form of —OSi can be confirmed by the ²⁹Si—NMR analysis of the hydrolysate of organosilane of the present invention or the partial condensate.

At this time, assuming that the case where three bonds of Si are condensed in the form of —OSi is (T3), the case where two bonds of Si are condensed in the form of —OSi is (T2), the case where one bond of Si is condensed in the form of —OSi is (T1) and the case where Si is not condensed at all is (T0), the condensation rate α is expressed by mathematical formula (II): α=(T3×3+T2×2+T1×1)/3/(T3+T2+T1+T0). The condensation rate is preferably from 0.2 to 0.95, more preferably from 0.3 to 0.93, still more preferably from 0.4 to 0.9.

The hydrolysate of the organosilane compound and the partial condensate for use in the present invention are described in detail.

The hydrolysis reaction of organosilane and the subsequent condensation reaction are generally performed in the presence of a catalyst. Examples of the catalyst include inorganic acids such as hydrochloric acid, sulfuric acid and nitric acid; organic acids such as oxalic acid, acetic acid, butyric acid, maleic acid, citric acid, formic acid, methanesulfonic acid and toluenesulfonic acid; inorganic bases such as sodium hydroxide, potassium hydroxide and ammonia; organic bases such as triethylamine and pyridine; metal alkoxides such as triisopropoxy aluminum, tetrabutoxy zirconium, tetrabutyl titanate and dibutyltin dilaurate; metal chelate compounds with the center metal being a metal such as Zr, Ti or Al; and F-containing compounds such as KF and NH4F.

One of these catalysts may be used alone or a plurality of species thereof may be used in combination.

The hydrolysis-condensation reaction of organosilane may be performed without a solvent or in a solvent, but in order to uniformly mix the components, an organic solvent is preferably used. Suitable examples thereof include alcohols, aromatic hydrocarbons, ethers, ketones and esters.

The solvent is preferably a solvent capable of dissolving the organosilane and the catalyst. In view of the process, the organic solvent is preferably used as a coating solution or a part of the coating solution. Furthermore, a solvent which does not impair the solubility or dispersibility when mixed with other materials such as fluorine-containing polymer is preferred.

Examples of the alcohols include a monohydric alcohol and a dihydric alcohol. The monohydric alcohol is preferably a saturated aliphatic alcohol having a carbon number of 1 to 8.

Specific examples of the alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether and ethylene glycol acetate monoethyl ether.

Specific examples of the aromatic hydrocarbons include benzene, toluene and xylene. Specific examples of the ethers include tetrahydrofuran and dioxane. Specific examples of the ketones include acetone, methyl ethyl ketone, methyl isobutyl ketone, diisobutyl ketone and cyclohexanone. Specific examples of the esters include ethyl acetate, propyl acetate, butyl acetate and propylene carbonate.

One of these organic solvents may be used alone, or two or more species thereof may be used as a mixture. The solid content concentration in the reaction is not particularly limited but is usually from 1 to 100%.

The reaction is performed by adding water in an amount of 0.05 to 2 mol, preferably 0.1 to 1 mol, per mol of the hydrolyzable group of organosilane, and stirring the resulting solution at 25 to 100° C. in the presence or absence of the above-described solvent and in the presence of a catalyst.

In the present invention, the hydrolysis is preferably performed by stirring the solution at 25 to 100° C. in the presence of at least one metal chelate compound where an alcohol represented by the formula: R⁷OH (wherein R⁷ represents an alkyl group having a carbon number of 1 to 10) and a compound represented by the formula: R⁸COCH₂COR⁹ (wherein R⁸ represents an alkyl group having a carbon number of 1 to 10 and R⁹ represents an alkyl group having a carbon number of 1 to 10 or an alkoxy group having a carbon number of 1 to 10) are present as ligands and the center metal is a metal selected from Zr, Ti and Al.

In the case of using an F-containing compound as the catalyst, the F-containing compound has a capability of allowing complete progress of hydrolysis and condensation and this is advantageous in that the polymerization degree can be determined by selecting the amount of water added and an arbitrary molecular weight can be designed. That is, in order to prepare an organosilane hydrolysate/partial condensate having an average polymerization degree of M, this may be attained by using water in an amount of (M−1) mol per M mol of the hydrolyzable organosilane.

Any metal chelate compound may be suitably used without particular limitation as long as it is a metal chelate compound where an alcohol represented by the formula: R⁷OH (wherein R⁷ represents an alkyl group having a carbon number of 1 to 10) and a compound represented by the formula: R⁸COCH₂COR⁹ (wherein R⁸ represents an alkyl group having a carbon number of 1 to 10 and R⁹ represents an alkyl group having a carbon number of 1 to 10 or an alkoxy group having a carbon number of 1 to 10) are present as ligands and the center metal is a metal selected from Zr, Ti and Al. Within this category, two or more kinds of metal chelate compounds may be used in combination. The metal chelate compound for use in the present invention is preferably selected from the group consisting of compounds represented by the formulae: Zr(OR⁷)ₚ₁(R⁸COCHCOR⁹)ₚ₂, Ti(OR⁷)_{q1}(R⁸COCHCOR⁹)_{q2} and AI(OR⁷)ᵣ₁(R⁸COCHCOR⁹)ᵣ₂. These compounds have an activity of accelerating the condensation reaction of the hydrolysate and partial condensate of the organosilane compound.

In the metal chelate compounds, R⁷ and R⁸ may be the same or different and each represents an alkyl group having a carbon number of 1 to 10, such as ethyl group, n-propyl group, i-propyl group, n-butyl group, sec-butyl group, tert-butyl group, n-pentyl group or phenyl group. R⁵ represents an alkyl group having a carbon number of 1 to 10 the same as above or an alkoxy group having a carbon number of 1 to 10, such as methoxy group, ethoxy group, n-propoxy group, i-propoxy group, n-butoxy group, sec-butoxy group or tert-butoxy group. In the metal chelate compounds, p1, p2, q1, q2, r1 and r2 each represents an integer determined to satisfy the relationships of p1+p2=4, q1+q2=4 and r1+r2=3.

Specific examples of the metal chelate compound include a zirconium chelate compound such as zirconium tri-n-butoxyethylacetoacetate, zirconium di-n-butoxy-bis-(ethylacetoacetate), zirconium n-butoxytris(ethylacetoacetate), zirconium tetrakis(n-propylacetoacetate), zirconium tetrakis(acetylacetoacetate) and zirconium tetrakis(ethylacetoacetate); a titanium chelate compound such as titanium diisopropoxy•bis(ethylacetoacetate), titanium diisopropoxy•bis(acetylacetate) and titanium diisopropoxy•bis(acetylacetone); and an aluminum chelate compound such as aluminum diisopropoxyethylacetoacetate, aluminum diisopropoxyacetylacetonate, aluminum isopropoxybis(ethylacetoacetate), aluminum isopropoxybis(acetylacetonate), aluminum tris(ethylacetoacetate), aluminum tris(acetylacetonate) and aluminum monoacetyl-acetonate•bis(ethylacetoacetate).

Among these metal chelate compounds, preferred are zirconium tri-n-butoxyethylacetoacetate, titanium diisopropoxybis(acetylacetonate), aluminum diisopropoxyethylacetoacetate and aluminum tris(ethylacetoacetate). One of these meal chelate compounds may be used alone, or two or more species thereof may be used as a mixture. A partial hydrolysate of such a metal chelate compound may also be used.

The metal chelate compound is preferably used in an amount of 0.01 to 50 mass %, more preferably from 0.1 to 50 mass %, still more preferably from 0.5 to 10 mass %, based on the organosilane compound. When the metal chelate compound is used in this range, the condensation reaction of the organosilane compound proceeds at a high rate, the coating film has good durability, and the composition comprising the hydrolysate and partial condensate of the organosilane compound and the metal chelate compound is assured of good storage stability.

In the coating solution for forming the low refractive index layer or other layers for use in the present invention, at least either one of a β-diketone compound and a β-ketoester compound is preferably added in addition to the composition containing the above-described sol component and metal chelate compound. This is further described below.

The compound for use in the present invention is at least either one of a β-diketone compound and a β-ketoester compound, represented by the formula: R⁸COCH₂COR⁹, and this compound functions as a stability enhancer for the composition used in the present invention. That is, this compound is considered to coordinate to a metal atom in the metal chelate compound (at lease one compound of zirconium, titanium and aluminum compounds) and inhibit the metal chelate compound from exerting the activity of accelerating the condensation reaction of the hydrolysate and partial condensate of the organosilane compound, whereby the storage stability of the composition obtained is improved. R⁸ and R⁹ constituting the β-diketone compound and the β-ketoester compound have the same meanings as R⁸ and R⁹ constituting the metal chelate compound above.

Specific examples of the β-diketone compound and the β-ketoester compound include acetylacetone, methyl acetoacetate, ethyl acetoacetate, n-propyl acetoacetate, i-propyl acetoacetate, n-butyl acetoacetate, sec-butyl acetoacetate, tert-butyl acetoacetate, 2,4-hexane-dione, 2,4-heptane-dione, 3,5-heptane-dione, 2,4-octane-dione, 2,4-nonane-dione and 5-methyl-hexane-dione. Among these, ethyl acetoacetate and acetylacetone are preferred, and acetylacetone is more preferred. One of these β-diketone compounds and β-ketoester compounds may be used alone, or two or more species thereof may be used as a mixture. In the present invention, the β-diketone compound and the β-ketoester compound each is preferably used in an amount of 2 mol or more, more preferably from 3 to 20 mol, per mol of the metal chelate compound. If the amount added is less than 2 mol, the composition obtained may have poor storage stability and this is not preferred.

The content of the hydrolysate and partial condensate of the organosilane compound is preferably small in the case of a relatively thin film, and preferably large in the case of a thick film. When the expression of effect, the refractive index, the shape and surface state of film and the like are taken account of, the content is preferably from 0.1 to 50 mass %, more preferably from 0.5 to 30 mass %, still more preferably from 1 to 15 mass %, based on the entire solid content of the layer containing it (the layer to which added).

(Polyfunctional Ionizing Radiation-Curable Monomer)

The coating composition (coating solution) for forming the low refractive index layer according to the present invention may contain a polyfunctional ionizing radiation-curable monomer. This monomer forms a coating film by bringing about chemical bonding upon irradiation with ionizing radiation after coating and drying the coating composition. The ionizing radiation-curable monomer is a monomer which is cured through a chemical reaction such as polymerization, addition polymerization or condensation polymerization by the effect of ionizing radiation. For example, monomers having an acryl group, a vinyl group, an epoxy group or the like are easily available and preferred.

It is also preferred to contain a heat-curable group in these monomers. For example, a hydroxyl group, an alkoxy group, a carboxyl group, an amino group, an epoxy group or an isocyanate group is preferably contained.

The functional group of the polyfunctional ionizing radiation-curable monomer is preferably a bifunctional or greater functional group, more preferably a trifunctional or greater functional group. Specific examples of such an ionizing radiation-curable monomer include the following monomers which are described later in regard to the antiglare hardcoat layer.

Specific examples of the polyfunctional ionizing radiation-curable monomer include an ester of a polyhydric alcohol and a (meth)acrylic acid (e.g., ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,2,3-cyclohexane tetramethacrylate, polyurethane polyacrylate, polyester polyacrylate); a vinylbenzene and a derivative thereof (e.g., 1,4-divinylbenzene, 2-acryloylethyl 4-vinylbenzoate, 1,4-divinylcyclohexanone); a vinylsulfone (e.g., divinylsulfone); an acrylamide (e.g., methylenebisacrylamide); and a methacrylamide. Two or more species of these monomers may be used in combination.

The amount added of the polyfunctional ionizing radiation-curable monomer in the coating composition is generally from 0.01 to 10 mass %, preferably from 0.1 to 5 mass %.

(Inorganic Fine Particle Having Void)

The low refractive index layer according to the present invention preferably contains an inorganic fine particle having a void in the inside of the particle so as to reduce the refractive index. The void is preferably porous or hollow, and the fine particle may also have a structure where inorganic fine particles are connected like a chain to form voids. In particular, an inorganic fine particle having a hollow structure is preferred.

The hollow inorganic fine particle is preferably a silica having a hollow structure. The refractive index of the hollow silica fine particle is preferably from 1.17 to 1.40, more preferably from 1.17 to 1.35, and most preferably from 1.17 to 1.30. The refractive index used here indicates a refractive index of the particle as a whole and does not indicate a refractive index of only silica as an outer shell forming the hollow silica particle. At this time, assuming that the radius of the cavity inside the particle is a and the radius of the outer shell of the particle is b, the porosity x calculated according the following mathematical formula (III) is preferably from 10 to 60%, more preferably from 20 to 60%, and most preferably from 30 to 60%.

Formula (III):
x=(4πa³/3)/(4πb³/3)×100

If the hollow silica particle is rendered to have a lower refractive index and a higher porosity, the thickness of the outer shell becomes small and the strength as a particle decreases. Therefore, in view of scratch resistance, a particle having a refractive index as low as less than 1.17 cannot be used.

Here, the refractive index of the hollow silica particle was measured by an Abbe's refractometer (manufactured by ATAGO K. K.).

The production method of the hollow silica is described, for example, in JP-A-2001-233611 and JP-A-2002-79616.

The amount of the hollow silica blended is preferably from 1 to 100 mg/m², more preferably from 5 to 80 mg/m², still more preferably from 10 to 60 mg/m². When the amount blended is in the above-described range, this ensures excellent scratch resistance, less generation of fine irregularities on the low refractive index layer surface, and enhancement of appearance (e.g., black reproduction) and integrated reflectance.

The average particle diameter of the hollow silica is preferably from 30 to 150%, more preferably from 35 to 80%, still more preferably from 40 to 60%, of the thickness of the low refractive index layer. In other words, when the thickness of the low refractive index layer is 100 nm, the particle diameter of the hollow silica is preferably from 30 to 150 nm, more preferably from 35 to 80 nm, still more preferably from 40 to 60 nm.

When the particle diameter of the silica fine particle is in the above-described range, this ensures reduction in the refractive index, less generation of fine irregularities on the low refractive index layer surface, and enhancement of appearance (e.g., black reproduction) and integrated reflectance. The silica fine particle may be crystalline or amorphous and is preferably a monodisperse particle. The shape is most preferably spherical but even if amorphous, there arises no problem.

The average particle diameter of the hollow silica can be determined from the electron micrograph.

In the present invention, a silica particle with no cavity may be used in combination with the hollow silica. The particle size of the silica with no cavity is preferably from 30 to 150 nm, more preferably from 35 to 80 nm, and most preferably from 40 to 60 nm.

Also, at least one species of a silica fine particle having an average particle size of less than 25% of the thickness of the low refractive index layer (this fine particle is referred to as a “small particle-size silica fine particle”) is preferably used in combination with the silica fine particle having the above-described particle diameter (this fine particle is referred to as a “large particle-size silica fine particle”).

The small particle-size silica fine particle can be present in a space between large particle-size silica fine particles and therefore, can contribute as a holding agent for the large particle-size silica fine particle.

The average particle diameter of the small particle-size silica fine particle is preferably from 1 to 20 nm, more preferably from 5 to 15 nm, still more preferably from 10 to 15 nm. Use of such a silica fine particle is preferred in view of the raw material cost and the holding agent effect.

For the purpose of stabilizing the dispersion in a liquid dispersion or coating solution or enhancing the affinity for or binding property with the binder component, the silica fine particle may be subjected to a physical surface treatment such as plasma discharge treatment and corona discharge treatment, or a chemical surface treatment with a surfactant, a coupling agent or the like. Use of a coupling agent is particularly preferred. As for the coupling agent, an alkoxy metal compound (e.g., titanium coupling agent, silane coupling agent) is preferably used. In particular, a treatment with a silane coupling agent having an acryloyl group or a methacryloyl group is effective.

This coupling agent is used as a surface treating agent for previously applying a surface treatment to the inorganic fine particle of the low refractive index layer before a coating solution for the low refractive index layer is prepared, but the coupling agent is preferably further added as an additive at the preparation of a coating solution for the low refractive index layer and incorporated into the layer.

The silica fine particle is preferably dispersed in a medium in advance of the surface treatment so as to reduce the load of the surface treatment.

(Fluorine- and/or Silicone-Based Compound)

The low refractive index layer according to the present invention preferably contains a fluorine- and/or silicone-based compound. By virtue of such a compound, the surface free energy can be reduced and in turn, the antifouling property, slipperiness, water resistance and the like can be enhanced.

As for such a compound, a known silicon-based or fluorine-based compound may be used. In the case of adding such a compound, the compound is preferably added in the range from 0.01 to 20 mass %, more preferably from 0.05 to 10 mass %, still more preferably from 0.1 to 5 mass %, based on the entire solid content of the low refractive index layer.

Preferred examples of the silicone-based compound include those containing a plurality of dimethylsilyloxy units as the repeating unit and having a substituent at the chain terminal and/or on the side chain of the compound. The chain of the compound containing dimethylsilyloxy as the repeating unit may contain a structural unit other than dimethylsilyloxy. A plurality of substituents, which may be the same or different, are preferably present. Preferred examples of the substituent include a group containing an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group or an amino group. The molecular weight is not particularly limited but is preferably 100,000 or less, more preferably 50,000 or less, still more preferably from 3,000 to 30,000, and most preferably from 10,000 to 20,000. The silicone atom content of the silicone-based compound is not particularly limited but is preferably 18.0 mass % or more, more preferably from 25.0 to 37.8 mass %, and most preferably from 30.0 to 37.0 mass %. Preferred examples of the silicone-based compound include, but are not limited to, X-22-174DX X-22-2426, X-22-164B, X22-164C, X-22-170DX, X-22-176D, X-22-1821 and FL100 (all trade names) produced by Shin-Etsu Chemical Co., Ltd.; and FM-0725, FM-7725, FM-4421, FM-5521, FM-6621 and FM-1121 produced by Chisso Corporation; DMS-U22, RMS-033, RMS-083, UMS-182, DMS-H21, DMS-H31, HMS-301, FMS121, FMS123, FMS131, FMS141 and FMS221 (all trade names) produced by Gelest; and TSF4460 produced by GE Toshiba Silicones Co., Ltd.).

The fluorine-based compound is preferably a compound having a fluoroalkyl group. The fluoroalkyl group preferably has a carbon number of 1 to 20, more preferably from 1 to 10, and may be linear (e.g., —CF₂CF₃, —CH₂(CF₂)₄H, —CH₂(CF₂)₈CF₃, —CH₂CH₂(CF₂)₄H), may have a branched structure (e.g., CH(CF₃)₂, CH₂CF(CF₃)₂, CH(CH₃)CF₂CF₃, CH(CH₃)(CF₂)₅CF₂H) or an alicyclic structure (preferably a 5- or 6-membered ring, for example, a perfluorocyclohexyl group, a perfluorocyclopentyl group or an alkyl group substituted by such a group) or may have an ether bond (e.g., CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H). A plurality of the fluoroalkyl groups may be contained within the same molecule.

The fluorine-based compound preferably further has a substituent which contributes to the bond formation or compatibility with the low refractive index layer film. A plurality of substituents, which may be the same or different, are preferably present. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group. The fluorine-based compound may be a polymer or oligomer with a compound not containing a fluorine atom. The molecular weight is not particularly limited. The fluorine atom content of the fluorine-based compound is not particularly limited but is preferably 20 mass % or more, more preferably from 30 to 70 mass %, and most preferably from 40 to 70 mass %. Preferred examples of the fluorine-based compound include, but are not limited to, R-2020, M-2020, R-3833 and M-3833 (all trade names) produced by Daikin Kogyo Co., Ltd.; Megafac F-171, F-172, F-179A and DYFENSA MCF-300 (all trade names) produced by Dai-Nippon Ink & Chemicals, Inc.; and MOIPER F Series produced by NOF Corp.

The fluorine- and/or silicon-containing compound preferably contains in its molecule at least one group having reactivity with the binder. Preferred examples of the reactive group include, as the heat-curable type, an active hydrogen, a hydroxyl group and melamine, and as the active energy ray-curable type, an acryloyl group and an epoxy group. Among these, melamine and a (meth)acryloyl group are more preferred.

In the present invention, for the purpose of preventing aggregation and precipitation of the inorganic filler, it is also preferred to use a dispersion stabilizer in combination in the coating solution for forming each layer. Examples of the dispersion stabilizer which can be used include a polyvinyl alcohol, a polyvinylpyrrolidone, a cellulose derivative, a polyamide, a phosphoric acid ester, a polyether, a surfactant, a silane coupling agent and a titanium coupling agent. In particular, the above-described silane coupling agent is preferred because the film after curing is strong.

The composition for forming the low refractive index layer of the present invention takes a liquid form and is produced by dissolving the above-described organosilane compound, its hydrolysate and/or a partial condensate thereof, and the fluorine-containing polymer, and if desired, further adding various additives such as inorganic fine particle, fluorine- and/or silicone-based compound, another binder and radical polymerization initiator, in an appropriate solvent. At this time, the solid content concentration is appropriately selected according to usage but is generally on the order of 0.01 to 60 mass %, preferably from 0.5 to 50 mass %, more preferably from 1 to 20 mass %. The layer thickness after curing of the low refractive index layer is preferably from 10 to 500 nm, more preferably from 20 to 300 nm, still more preferably from 30 to 200 nm.

The addition of additives such as curing agent is not necessarily advantageous in view of the film hardness of the low refractive index layer, but in the light of interface adhesion to the high refractive index layer or the like, a curing agent such as polyisocyanate compound, aminoplast, polybasic acid and its anhydrate may be added in a small amount. In the case of adding such an additive, the amount added thereof is preferably from 0 to 30 mass %, more preferably from 0 to 20 mass %, still more preferably from 0 to 10 mass %, based on the entire solid content of the low refractive index layer film.

For the purpose of imparting properties such as dust protection and antistatic property, a dust inhibitor, an antistatic agent and the like such as known cationic surfactant and polyoxyalkylene-based compound may be appropriately added. A structural unit of such a dust inhibitor or antistatic agent may be contained as a part of the function in the above-described silicone-based compound or fluorine-based compound. In the case of adding such an additive, the additive is preferably added in the range from 0.01 to 20 mass %, more preferably from 0.05 to 10 mass %, still more preferably from 0.1 to 5 mass %, based on the entire solid content of the lower refractive index layer. Preferred examples of the compound include, but are not limited to, Megafac F-150 (trade name) produced by Dai-Nippon Ink & Chemicals, Inc. and SH-3748 (trade name) produced by Toray Dow Corning.

Other layers in the optical film of the present invention are described below.

[Antistatic Layer]

Examples of the method for forming an antistatic layer include conventionally known methods such as a method of coating an electrically conducting coating solution containing an electrically conducting fine particle and a reactive curable resin, and a method of vapor-depositing or sputtering a transparent film-forming metal or metal oxide or the like to form an electrically conducting thin film. The antistatic layer may be formed directly on a substrate film or through a primer layer ensuring firm adhesion to the substrate film. Also, the antistatic layer may be used as a part of the antireflection film. In this case, when used as a layer closer to the outermost layer, a sufficiently high antistatic property can be obtained even with a small film thickness.

The thickness of the antistatic layer is preferably from 0.01 to 10 μm, more preferably from 0.03 to 7 μm, still more preferably from 0.05 to 5 μm. The surface resistance value (logSR) of the antistatic layer of the present invention at 25° C. and 55% RH is preferably 12 Ω/sq or less, more preferably 10 Ω/sq or less. Also, for satisfying the transparency of the coating film at the same time, the surface resistance value is preferably 5 Ω/sq or more. That is, the surface resistance value of the antistatic layer of the present invention at 25° C. and 55% RH is preferably from 5 to 12 Ω/sq, more preferably from 5 to 10 Ω/sq.

The surface resistance of the antistatic layer may be measured by the four-probe method.

When the surface resistance of the antistatic layer is in the above-described range, a transparent antireflection film with good dust protection can be obtained.

The antistatic layer is preferably an electron conducting type of causing less change in the surface resistance value depending on the ambient temperature and humidity.

The antistatic layer is preferably transparent in substance. Specifically, the haze of the antistatic layer is preferably 10% or less, more preferably 5% or less, still more preferably 3% or less, and most preferably 1% or less. Furthermore, the transmittance for light at a wavelength of 550 nm is preferably 50% or more, more preferably 60% or more, still more preferably 65% or more, and most preferably 70% or more.

The antistatic layer of the present invention has excellent strength. Specifically, the strength of the antistatic layer is, in terms of the pencil hardness with a load of 1 kg (specified in JIS-K-5400), preferably H or more, more preferably 2H or more, still more preferably 3H or more, and most preferably 4H or more.

The electrically conducting inorganic fine particle contained in the antistatic layer of the present invention is preferably formed of a metal oxide or nitride. Examples of the metal oxide or nitride include tin oxide, indium oxide, zinc oxide and titanium nitride. Among these, tin oxide and indium oxide are preferred. The electrically conducting inorganic fine particle comprises such a metal oxide or nitride as the main component and may further contain other elements. The main component means a component having a largest content (mass %) out of the components constituting the particle. Examples of the other element include Ti, Zr, Sn, Sb, Cu, Fe, Mn, Pb, Cd, As, Cr, Hg, Zn, Al, Mg, Si, P, S, B, Nb, In, V and a halogen atom. In order to enhance the electrical conductivity of tin oxide or indium oxide, addition of Sb, P, B, Nb, In, V or a halogen atom is preferred. An Sb-containing tin oxide (ATO) and an Sn-containing indium oxide (ITO) are particularly preferred. The ratio of Sb in ATO is preferably from 3 to 20 mass %, and the ratio of Sn in ITO is preferably from 5 to 20 mass %.

In the antistatic layer, a crosslinked polymer may be used as the binder. The crosslinking polymer preferably has an anionic group. In the crosslinking polymer having an anionic group, the main chain of the anionic group-containing polymer has a crosslinked structure. The anionic group has a function of maintaining the dispersed state of electrically conducting inorganic fine particles, and the crosslinked structure has a function of imparting a film-forming ability to the polymer and strengthening the antistatic layer.

The anionic group-containing crosslinking polymer is preferably a polymer having a polyolefin (saturated hydrocarbon), a polyether, a polyurea, a polyurethane, a polyamine, a polyamide or the like as the main chain, or a melamine resin. In particular, a polyolefin main chain, a polyether main chain and a polyurea main chain are preferred, a polyolefin main chain and a polyether main chain are more preferred, and a polyolefin main chain is most preferred.

[Hardcoat Layer]

As for the hardcoat layer, a so-called smooth hardcoat layer having no antiglare property is also preferably used so as to impart a physical strength to the optical film, and this layer is provided on the surface of the transparent support, preferably between the transparent support and the above-described functional layer (antistatic layer or light-diffusing layer).

The hardcoat layer is preferably formed through a crosslinking reaction or polymerization reaction of an ionizing radiation-curable compound. For example, a coating composition containing an ionizing radiation-curable polyfunctional monomer or oligomer is coated on a transparent support, and a crosslinking reaction or polymerization reaction of the polyfunctional monomer or oligomer is brought about, whereby the hardcoat layer can be formed.

The functional group in the ionizing radiation-curable polyfunctional monomer or oligomer is preferably a photopolymerizable functional group, an electron beam-polymerizable functional group or a radiation-polymerizable functional group, more preferably a photopolymerizable functional group.

Examples of the photopolymerizable functional group include an unsaturated polymerizable functional group such as (meth)acryloyl group, vinyl group, styryl group and allyl group. Among these, a (meth)acryloyl group is preferred.

Specific examples of the photopolymerizable polyfunctional monomer having a photopolymerizable functional group include those described as the examples of the polyfunctional ionizing radiation-curable monomer. This monomer is preferably polymerized by using a photopolymerization initiator or a photosensitizer. The photopolymerization reaction is preferably performed by irradiating an ultraviolet ray after coating and drying the hardcoat layer.

In the hardcoat layer, an oligomer and/or a polymer each having a mass average molecular weight of 500 or more may be added so as to impart brittleness.

Examples of the oligomer and polymer include a (meth)acrylate-based polymer, a cellulose-based polymer, a styrene-based polymer, a urethane acrylate and a polyester acrylate. For example, a poly(glycidyl (meth)acrylate) or poly(allyl (meth)acrylate) having functional group on the side chain is preferred.

The content of the oligomer and/or polymer in the hardcoat layer is preferably from 5 to 80 mass %, more preferably from 25 to 70 mass %, still more preferably from 35 to 65 mass %, based on the entire mass of the hardcoat layer.

The binder of the hardcoat layer is added in an amount of 30 to 95 mass % based on the solid content of the coating composition for the layer.

The hardcoat layer preferably contains an inorganic fine particle having an average primary particle diameter of 200 nm or less. The average particle diameter as used herein is a mass average diameter. With an average primary particle diameter of 200 nm or less, a hardcoat layer of not impairing the transparency can be formed.

The inorganic fine particle has a function of not only increasing the hardness of the hardcoat layer but also suppressing the cure shrinkage of the coated layer. The inorganic fine particle is added also for the purpose of controlling the refractive index of the hardcoat layer.

Examples of the inorganic fine particle include, in addition to the inorganic fine particles described in regard to the high refractive index layer, fine particles of silicon dioxide, aluminum oxide, calcium carbonate, barium sulfate, talc, kaolin, calcium sulfate, titanium dioxide, zirconium oxide, tin oxide, ITO and zinc oxide. Among these, preferred are silicon dioxide, titanium dioxide, zirconium oxide, aluminum oxide, tin oxide, ITO and zinc oxide.

The average primary particle diameter of the inorganic fine particles is preferably from 5 to 200 nm, more preferably from 10 to 150 nm, still more preferably from 20 to 100 nm, yet still more preferably from 20 to 50 nm.

In the hardcoat layer, the inorganic fine particle is preferably dispersed to have a particle diameter as small as possible.

The particle size of the inorganic fine particle in the hardcoat layer is, in terms of the average particle diameter, preferably from 5 to 300 nm, more preferably from 10 to 200 nm, still more preferably from 20 to 150 nm, yet still more preferably from 20 to 80 nm.

The content of the inorganic fine particle in the hardcoat layer is preferably from 10 to 90 mass %, more preferably from 15 to 80 mass %, still more preferably from 15 to 75 mass %, based on the entire mass of the hardcoat layer.

The thickness of the hardcoat layer can be appropriately designed according to usage. The thickness of the hardcoat layer is preferably from 0.2 to 10 μm, more preferably from 0.5 to 7 μm, still more preferably from 0.7 to 5 μm.

The hardness of the hardcoat layer is preferably H or more, more preferably 2H or more, and most preferably 3H or more, in the pencil hardness test according to JIS K5400.

Furthermore, in the Taber test according to JIS K5400, the abrasion loss of the specimen between before and after test is preferably smaller.

In forming the hardcoat layer, when the hardcoat layer is formed through a crosslinking or polymerization reaction of an ionizing radiation-curable compound, the crosslinking or polymerization reaction is preferably performed in an atmosphere having an oxygen concentration of 10 vol % or less. By the reaction in an atmosphere having an oxygen concentration of 10 vol % or less, a hardcoat layer having excellent physical strength and chemical resistance can be formed.

The hardcoat layer is preferably formed by a crosslinking or polymerization reaction of an ionizing radiation-curable compound in an atmosphere having an oxygen concentration of 6 vol % or less, more preferably 4 vol % or less, still more preferably 2 vol % or less, and most preferably 1 vol % or less.

The oxygen concentration is preferably adjusted to 10 vol % or less by a method of displacing the air (nitrogen concentration: about 79 vol %, oxygen concentration: about 21 vol %) with another gas, more preferably with nitrogen (nitrogen purging).

The hardcoat layer is preferably formed on the transparent support surface by a coating method after appropriately diluting a coating composition for forming the hardcoat layer with an organic solvent.

[Transparent Support]

The transparent support for use in the optical film of the present invention is preferably a plastic film. Examples of the polymer for forming the plastic film include a cellulose acylate (e.g., triacetyl cellulose, diacetyl cellulose; as represented by TAC-TD80U and TD80UF produced by Fuji Photo Film Co., Ltd.), a polyamide, a polycarbonate, a polyester (e.g., polyethylene terephthalate, polyethylene naphthalate), a polystyrene, a polyolefin, a norbornene-based resin (ARTON, trade name, produced by JSR) and an amorphous polyolefin (ZEONEX, trade name, produced by Nippon Zeon). Among these, preferred are triacetyl cellulose, polyethylene terephthalate and polyethylene naphthalate, and more preferred is triacetyl cellulose.

The triacetyl cellulose comprises a single layer or a plurality of layers. The single-layer triacetyl cellulose is prepared, for example, by drum casting disclosed in JP-A-7-11055 or band casting, and the triacetyl cellulose comprising a plurality of layers is prepared by a so-called co-casting method disclosed in JP-A-61-94725 and JP-B-62-43846 (the term “JP-B” as used herein means an “examined Japanese patent publication”). More specifically, this is a method where when a solution (called a “dope”) prepared by dissolving a raw material flake in a solvent such as halogenated hydrocarbons (e.g., dichloromethane), alcohols (e.g., methanol, ethanol, butanol), esters (e.g., methyl formate, methyl acetate) and ethers (e.g., dioxane, dioxolane, diethyl ether), and adding, if desired, various additives such as plasticizer, ultraviolet absorbent, deterioration inhibitor, lubricant and separation accelerator is cast on a support comprising a horizontal endless metal belt or a rotating drum by dope supply means (called a “die”), a single dope is cast into a single layer in the case of a single layer or a high-concentration cellulose ester dope and low-concentration dopes on both sides thereof are co-cast in the case of a plurality of layers, and the film imparted with rigidity by the drying to some extent on the support is separated from the support and passed through a drying zone by various transportation devices to remove the solvent.

The refractive index of the triacetyl cellulose is preferably from 1.46 to 1.49, more preferably from 1.47 to 1.48.

A representative example of the solvent for dissolving the triacetyl cellulose is dichloromethane. However, in view of the global environment or working environment, the solvent preferably contains substantially no halogenated hydrocarbon such as dichloromethane. The term “contain substantially no halogenated hydrocarbon” as used herein means that the proportion of the halogenated hydrocarbon in the organic solvent is less than 5 mass % (preferably less than 2 mass %).

In the case of preparing a triacetyl cellulose dope by using a solvent containing substantially no dichloromethane), a special dissolution method described later becomes necessary.

In the case of using the optical film of the present invention for a liquid crystal display device, the optical film is preferably disposed on the outermost surface of the display, for example, by providing a pressure-sensitive adhesive layer on one surface. In this case, the light-diffusing layer or the low refractive index layer is preferably disposed on the viewing side. Also, the antireflection film of the present invention may be combined with a polarizing film. In the case where the transparent support is triacetyl cellulose, since triacetyl cellulose is used as a protective film for protecting the polarizing layer of the polarizing plate, the antireflection film of the present invention is preferably used directly as the protective film in view of the cost.

The antireflection film of the present invention is made so that the light-diffusing layer or the low refractive index layer is preferably disposed on the viewing side, and in the case where the antireflection film of the present invention is disposed on the outermost surface of the display, for example, by providing a pressure-sensitive adhesive layer on one surface or is used directly as the protective film of a polarizing plate, the transparent support after the formation of an outermost layer thereon is preferably subjected to a saponification treatment so as to ensure satisfactory adhesion. The saponification treatment is performed by a known method, for example, by dipping the film in an alkali solution for an appropriate time period. After dipping in an alkali solution, the film is preferably well washed with water or dipped in a dilute acid to neutralize the alkali component and allow for no remaining of the alkali component in the film.

By performing a saponification treatment, the surface of the transparent support on the side opposite the surface having the outermost layer is hydrophilized.

The hydrophilized surface is effective particularly for improving the adhesive property to a polarizing film mainly comprising a polyvinyl alcohol. Furthermore, the hydrophilized surface hardly allows for attachment of dust in air and therefore, dust scarcely intrudes into the space between the polarizing film and the antireflection film at the bonding to a polarizing film, so that point defects due to dust can be effectively prevented.

The saponification treatment is preferably performed such that the surface of the transparent support on the side opposite the surface having the outermost layer has a contact angle with water of 400 or less, more preferably 30° or less, still more preferably 20° or less.

The method for the alkali saponification treatment can be specifically selected from the following two methods (1) and (2). The method (1) is advantageous in that the treatment can be performed by the same process as that for the general-purpose triacetyl cellulose film, but since the antireflection film surface is also saponified, there may arise a problem that the film deteriorates resulting from alkali hydrolysis of the surface or when the solution for saponification treatment remains, this causes staining. In such a case, the method (2) is advantageous, though this is a special process.

(1) After the formation of each coating layer on a transparent support, the support is dipped at least once in an alkali solution, whereby the back surface of the film is saponified.

(2) Before or after the formation of a coating layer on a transparent support, an alkali solution is applied to the surface of the optical film on the side opposite the coated surface, and then the film is heated, washed with water and/or neutralized, whereby only the back surface of the film is saponified.

[Coating System]

The optical film of the present invention can be formed by the following method, but the present invention is not limited to this method.

First, a coating solution containing components for forming each layer is prepared. The coating solution prepared for forming various functional layers is coated on a transparent support by a dip coating method, an air knife coating method, a curtain coating method, a roller coating method, a wire bar coating method, a gravure coating method or a die coating method, and then heated and dried. Among these coating methods, a microgravure coating method, a wire bar coating method and a die coating method are preferred, a die coating method is more preferred, and a coating method using a die of which construction is designed as described in JP-A-2006-122889 is most preferred.

After coating, the monomer forming the functional layer is cured through polymerization under light irradiation or heating to form the functional layer. Here, if desired, a plurality of functional layers may be formed.

Next, a coating solution for forming the low refractive index layer is coated on the functional layer in the same manner and then irradiated with light or heated (cured by irradiating ionizing radiation such as ultraviolet ray, preferably irradiating ionizing radiation under heating) to form the low refractive index layer. In this way, the optical film of the present invention is obtained.

The microgravure coating method for use in the present invention is a coating method characterized in that a gravure roll having a diameter of about 10 to 100 mm, preferably from about 20 to 50 mm, and having a gravure pattern stamped on the entire circumference is rotated under the support in the direction reverse to the support-transporting direction and at the same time, an extra coating solution is scraped off from the surface of the gravure roll by a doctor blade, whereby a constant amount of the coating solution is transferred to and coated on the lower surface of the support while the upper surface of the support is left in a free state. A roll-form transparent support is continuously unrolled and on one surface of the unrolled support, at least a hard coat layer or at least one low refractive index layer comprising a fluorine-containing polymer can be coated by the microgravure coating method.

The polarizing plate mainly comprises a polarizing film and two protective films sandwiching the polarizing film from both sides. The antireflection film of the present invention is preferably used for at least one protective film out of two protective films sandwiching the polarizing film from both sides. By arranging the antireflection film of the present invention to serve also as a protective film, the production cost of the polarizing plate can be reduced. Furthermore, by using the antireflection film of the present invention as an outermost surface layer, a polarizing plate prevented from the projection or the like of outside light and excellent also in the scratch resistance, antifouling property and the like can be obtained.

As for the polarizing film, a known polarizing film or a polarizing film cut out from a lengthy polarizing film with the absorption axis of the polarizing film being neither parallel nor perpendicular to the longitudinal direction, may be used. The lengthy polarizing film with the absorption axis of the polarizing film being neither parallel nor perpendicular to the longitudinal direction is produced by the following method.

This is a polarizing film obtained through stretching by applying a tension to a continuously fed polymer film while holding both edges of the film with holding means and can be produced according to a stretching method where the film is stretched to 1.1 to 20.0 times at least in the film width direction, the holding devices at both edges of the film are moved to create a difference in the travelling speed of 3% or less in the longitudinal direction, and the film travelling direction is bent, in the state of the film being held at both edges, such that the angle made by the film travelling direction at the outlet in the step of holding both edges of the film and the substantial stretching direction of the film inclines at 20 to 70°. Particularly, a polarizing film produced with an inclination angle of 45° is preferred in view of productivity.

The stretching method of a polymer film is described in detail in JP-A-2002-86554 (paragraphs [0020] to [0030]).

Out of two protective films of the polarizer, the film other than the antireflection film is preferably an optical compensation film having an optical compensation layer comprising an optically anisotropic layer. The optical compensation film (retardation film) can improve the viewing angle properties of a liquid crystal display screen.

The optical compensation film may be a known optical compensation film but from the standpoint of enlarging the viewing angle, an optical compensation film described in JP-A-2001-100042 where an optical compensation layer comprising a compound having a discotic structure unit is provided and the angle made by the discotic compound and the support is changing in the depth direction of the layer, is preferred.

This angle is preferably increasing as the distance from the support plane side of the optically anisotropic layer increases.

Out of two protective films of the polarizer, the transparent support of at least one protective film preferably satisfies the following formulae (I) and (II), because the effect of improving the display viewed from the oblique direction of a liquid crystal display screen is high. In particular, the transparent support of the present invention preferably satisfies the following formulae (I) and (II).

(I): 0≦Re(630)≦10 and |Rth(630)|≦25

(II): |Re(400)−Re(700)|≦10 and |Rth(400)−Rth(700)|≦35

The optical film of the present invention can be applied to an image display device such as liquid crystal display device (LCD), plasma display panel (PDP), electroluminescent display (ELD) and cathode ray tube display device (CRT). Since the antireflection film of the present invention has a transparent support, this film is used by bonding the transparent support side to the image display surface of the image display device.

In the case of using the optical film of the present invention as one surface protective film of a polarizing film, the optical film can be preferably used for a transmissive, reflective or transflective liquid crystal display device in a mode such as twisted nematic (TN) mode, super twisted nematic (STN) mode, vertical alignment (VA) mode, in-plane switching (IPS) mode, optically compensated bend cell (OCB) mode and electrically controlled birefringence (ECB) mode.

The VA-mode liquid crystal cell includes (1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625); (2) a (MVA-mode) liquid crystal cell where the VA mode is modified to a multi-domain system for enlarging the viewing angle (described in SID97, Digest of Tech. Papers (preprints), 28, 845 (1997)); (3) a (n-ASM-mode) liquid crystal cell where rod-like liquid crystalline molecules are oriented substantially in the vertical alignment at the time of not applying a voltage and oriented in the twisted multi-domain alignment at the time of applying a voltage (described in preprints of Nippon Ekisho Toronkai (Liquid Crystal Forum of Japan), 58-59 (1998)); and (4) a SURVAIVAL-mode liquid crystal cell (reported in LCD International 98).

The OCB-mode liquid crystal cell is a liquid crystal display device using a liquid crystal cell of bend alignment mode where rod-like liquid crystalline molecules are aligned substantially in opposite directions (symmetrically) at the upper part and the lower part of the liquid crystal cell, and this is disclosed in U.S. Pat. Nos. 4,583,825 and 5,410,422. Since rod-like liquid crystalline molecules are aligned symmetrically between the upper part and the lower part of the liquid crystal cell, the liquid crystal cell of bend alignment mode has a self-optically compensating ability. Accordingly, this liquid crystal mode is also called an OCB (optically compensatory bend) liquid crystal mode. A liquid crystal display device of bend alignment mode is advantageous in that the response speed is fast.

The entirety including a polarizing plate comprising a bend alignment-mode liquid crystal cell and an optically anisotropic layer preferably has optical properties satisfying the following formula (1′) in the measurement at any wavelength of 450 nm, 550 nm and 630 nm, because the effect of improving the display viewed from the oblique direction of a liquid crystal display screen is high. In particular, the polarizing plate using the optical film of the present invention as a protective film preferably satisfies the following formula (1′).

Formula (1′):
0.05<(Δn×d)/(Re×Rth)<0.20
[wherein Δn is the intrinsic birefringence of the rod-like liquid crystal molecule in the liquid crystal cell, d is the liquid crystal layer thickness (unit: nm) of the liquid crystal cell, Re is the in-plane retardation value of the optically anisotropic layer as a whole, and Rth is the retardation value in the thickness direction of the optically anisotropic layer as a whole].

In the ECB-mode liquid crystal cell, rod-like liquid crystalline molecules are oriented substantially in the horizontal alignment at the time of not applying a voltage. This is most popularly used as a color TFT liquid crystal display device and is described in a large number of publications such as EL, PDP. LCD Display, Toray Research Center (2001).

Particularly, in the case of a TN-mode or IPS-mode liquid crystal display device, as described in JP-A-2001-100043 and the like, an optical compensation film having an effect of enlarging the viewing angle is preferably used for the protective film on the surface opposite the antireflection film of the present invention out of front and back two protective films of a polarizing film, because a polarizing plate having an antireflection effect and a viewing angle-enlarging effect with a thickness of one polarizing plate can be obtained.

### EXAMPLES

The present invention is described in greater detail below by referring to Examples, but the present invention should not be construed as being limited thereto. Unless otherwise indicated, the “parts” and “%” are on the mass basis.

(Preparation of Sol Solution a-1)

In a 1,000 ml-volume reaction vessel equipped with a thermometer, a nitrogen inlet tube and a dropping funnel, 187 g (0.80 mol) of acryloyloxypropyltrimethoxysilane, 29.0 g (0.21 mol) of methyltrimethoxysilane, 320 g (10 mol) of methanol and 0.06 g (0.001 mol) of KF were charged, and 17.0 g (0.94 mol) of water was gradually added dropwise with stirring at room temperature. After the completion of dropwise addition, the solution was stirred for 3 hours at room temperature and then heated with stirring for 2 hours under reflux of methanol. Thereafter, the low boiling point fraction was removed by distillation under reduced pressure, and the residue was filtered to obtain 120 g of Sol Solution a-1. The thus-obtained substance was measured by GPC, as a result, the mass average molecular weight was 1,500 and out of the oligomer or higher components, the proportion of the components having a molecular weight of 1,000 to 20,000 was 30%.

Also, from the 1H-NMR measurement results, the structure of the obtained substance was the structure represented by the following formula:

Average Composition Formula:
(CH₂═COO—C₃H₆)_{0.8}(CH₃)_{0.2}SiO_{0.86}(OCH₃)_{1.28}

Furthermore, the condensation rate α as measured by ²⁹Si—NMR was 0.59. From these analysis results, it was found that the majority of this silane coupling agent sol was a linear structure portion.

Also, the gas chromatography analysis revealed that the residual ratio of the raw material acryloxypropyltrimethoxysilane was 5% or less.

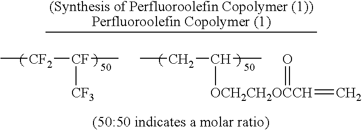

In a stainless steel-made autoclave having an internal volume of 100 ml and equipped with a stirrer, 40 ml of ethyl acetate, 14.7 g of hydroxyethyl vinyl ether and 0.55 g of dilauroyl peroxide were charged, and the inside of the system was deaerated and displaced with nitrogen gas. Furthermore, 25 g of hexafluoropropylene (HFP) was introduced into the autoclave, and the temperature was elevated to 65° C. The pressure when the temperature in the autoclave reached 65° C. was 5.4 kg/cm². The reaction was continued for 8 hours while keeping this temperature and when the pressure reached 3.2 kg/cm², the heating was stopped and the system was allowed to cool. When the inner temperature dropped to room temperature, the unreacted monomer was expelled, and the autoclave was opened to take out the reaction solution. The obtained reaction solution was poured in a large excess of hexane and after removing the solvent by decantation, the precipitated polymer was taken out. This polymer was dissolved in a small amount of ethyl acetate, and the residual monomer was completely removed by performing reprecipitation from hexane twice. After drying, 28 g of the polymer was obtained. Subsequently, 20 g of the polymer was dissolved in 100 ml of N,N-dimethylacetamide, and 11.4 g of acrylic acid chloride was added dropwise thereto under ice cooling, followed by stirring at room temperature for 10 hours. Thereafter, ethyl acetate was added to the reaction solution, and the resulting solution was washed with water. The organic layer was extracted and concentrated, and the obtained polymer was reprecipitated from hexane to obtain 19 g of Perfluoroolefin Copolymer (1). The refractive index of the obtained polymer was 1.421.

Composition of Coating Solution T for Antistatic Layer

| | |
|---|---|
| Peltron C-4456-S7 | 100 g |
| Cyclohexanone | 30 g |
| Methyl ethyl ketone | 10 g |
| KBM-5103 | 1.5 g |

The coating solution above was filtered through a polypropylene-made filter having a pore size of 10 μm to prepare a coating solution for antistatic layer.

Composition of Coating Solution A-1 for Light-Diffusing Layer

| | |
|---|---|
| PET-30 | 50.0 g |
| Irgacure 184 | 2.0 g |
| SX-500H (30%) | 14.5 g |
| FP-149 | 0.75 g |
| Sol Solution a-1 | 10.0 g |
| Toluene | 38.5 g |
| Methyl ethyl ketone | 12.0 g |

Composition of Coating Solution A-2 for Light-Diffusing Layer

| | |
|---|---|
| PET-30 | 50.0 g |
| Irgacure 184 | 2.0 g |
| Crosslinked poly(acryl-styrene) particle of 5 μm (30%) | 14.5 g |
| FP-149 | 0.75 g |
| Sol Solution a-1 | 10.0 g |
| Toluene | 38.5 g |
| Methyl ethyl ketone | 12.0 g |

Composition of Coating Solution A-3 for Light-Diffusing Layer

| | |
|---|---|
| PET-30 | 50.0 g |
| Irgacure 184 | 2.0 g |
| Crosslinked polystyrene particle of 8 μm (30%) | 14.5 g |
| FP-149 | 0.75 g |
| Sol Solution a-1 | 10.0 g |
| Toluene | 38.5 g |
| Methyl ethyl ketone | 12.0 g |

Composition of Coating Solution A-4 for Light-Diffusing Layer

| | |
|---|---|
| PET-30 | 50.0 g |
| Irgacure 184 | 2.0 g |
| Crosslinked polystyrene particle of 13 μm (30%) | 14.5 g |
| FP-149 | 0.75 g |
| Sol Solution a-1 | 10.0 g |
| Toluene | 38.5 g |
| Methyl ethyl ketone | 12.0 g |

Composition of Coating Solution A-5 for Light-Diffusing Layer

| | |
|---|---|
| PET-30 | 30.0 g |
| Epoxy Compound 1 | 20.0 g |
| Irgacure 184 | 2.0 g |
| UVI-6990 | 1.2 g |
| Crosslinked polystyrene particle of 8 μm (30%) | 14.5 g |
| FP-149 | 0.75 g |
| Sol Solution a-1 | 10.0 g |
| Toluene | 38.5 g |
| Methyl ethyl ketone | 12.0 g |

Composition of Coating Solution A-6 for Light-Diffusing Layer

| | |
|---|---|
| HP-7200L | 50.0 g |
| UVI-6990 | 3.8 g |
| Crosslinked polystyrene particle of 8 μm (30%) | 14.5 g |
| FP-149 | 0.75 g |
| Sol Solution a-1 | 10.0 g |
| Toluene | 38.5 g |
| Methyl ethyl ketone | 12.0 g |

Composition of Coating Solution A-7 for Light-Diffusing Layer

| | |
|---|---|
| GT-401 | 50.0 g |
| UVI-6990 | 3.8 g |
| Crosslinked polystyrene particle of 8 μm (30%) | 14.5 g |
| FP-149 | 0.75 g |
| Sol Solution a-1 | 10.0 g |
| Toluene | 38.5 g |
| Methyl ethyl ketone | 12.0 g |

Composition of Coating Solution A-8 for Light-Diffusing Layer

| | |
|---|---|
| PET-30 | 37.0 g |
| Irgacure 184 | 2.0 g |
| MS-300K | 37.2 g |
| Crosslinked polystyrene particle of 8 μm (30%) | 14.5 g |
| FP-149 | 0.75 g |
| Sol Solution a-1 | 10.0 g |
| Toluene | 14.3 g |
| Methyl ethyl ketone | 12.0 g |

In the coating solution above, the refractive index of only the binder was 1.51, and the refractive index of MS-300K was 1.50.

Composition of Coating Solution A-9 for Light-Diffusing Layer

| | |
|---|---|
| PET-30 | 28.0 g |
| Irgacure 184 | 1.4 g |
| MX-150 (40%) | 55.0 g |
| Crosslinked polystyrene particle of 8 μm (30%) | 14.5 g |
| FP-149 | 0.75 g |
| Sol Solution a-1 | 10.0 g |
| Toluene | 5.5 g |
| Methyl ethyl ketone | 12.0 g |

In the coating solution above, the refractive index of only the binder was 1.51, and the refractive index of MX-150 was 1.50.

Composition of Coating Solution A-10 for Light-Diffusing Layer

| | | |
|---|---|---|
| PET-30 | 30.0 | g |
| Irgacure-184 | 1.7 | g |
| Desolite Z7404 | 45.0 | g |
| Crosslinked polystyrene particle of 8 μm (30%) | 14.5 | g |
| FP-149 | 0.75 | g |
| Sol Solution a-1 | 10.0 | g |
| Toluene | 13.5 | g |
| Methyl ethyl ketone | 12.0 | g |

Composition of Coating Solution A-11 for Light-Diffusing Layer

| | | |
|---|---|---|
| PET-30 | 35.0 | g |
| Irgacure 184 | 1.7 | g |
| Polymethyl methacrylate solution (30%) | 50.0 | g |
| Crosslinked polystyrene particle of 8 μm (30%) | 14.5 | g |
| FP-149 | 0.75 | g |
| Sol Solution a-1 | 10.0 | g |
| Toluene | 15.5 | g |

Composition of Coating Solution A-11B for Light-Diffusing Layer

| | | |
|---|---|---|
| PET-30 | 40.0 | g |
| Irgacure 184 | 1.7 | g |
| SHIKO UV-6100B | 10.0 | g |
| Crosslinked polystyrene particle of 8 μm (30%) | 14.5 | g |
| FP-149 | 0.75 | g |
| Sol Solution a-1 | 10.0 | g |
| Toluene | 50.5 | g |

Composition of Coating Solution A-12 for Light-Diffusing Layer

| | | |
|---|---|---|
| PET-30 | 30.0 | g |
| Irgacure 184 | 1.2 | g |
| Hydrolysate of Si(OC₂H₅)₄ with hydrochloric acid | 20.0 | g |
| Crosslinked polystyrene particle of 8 μm (30%) | 14.5 | g |
| FP-149 | 0.75 | g |
| Sol Solution a-1 | 10.0 | g |
| n-Propanol | 38.5 | g |
| Methyl ethyl ketone | 12.0 | g |

Composition of Coating Solution A-13 for Light-Diffusing Layer

| | | |
|---|---|---|
| PET-30 | 30.0 | g |
| Irgacure 184 | 1.2 | g |
| Hydrolysate of CH₃(CH₂)₂Si(OC₂H₅)₃ with hydrochloric acid | 20.0 | g |
| Crosslinked polystyrene particle of 8 μm (30%) | 14.5 | g |
| FP-149 | 0.75 | g |
| Sol Solution a-1 | 10.0 | g |
| n-Propanol | 38.5 | g |
| Methyl ethyl ketone | 12.0 | g |

Composition of Coating Solution A-14 for Light-Diffusing Layer

| | | |
|---|---|---|
| PET-30 | 50.0 | g |
| Irgacure 184 | 2.0 | g |
| Crosslinked polystyrene particle of 8 μm (30%) | 14.5 | g |
| FP-149 | 0.75 | g |
| Sol Solution a-1 | 10.0 | g |
| Methyl isobutyl ketone | 38.5 | g |
| Methyl ethyl ketone | 12.0 | g |

Composition of Coating Solution A-15 for Light-Diffusing Layer

| | | |
|---|---|---|
| DPHA | 25.0 | g |
| Irgacure 184 | 2.0 | g |
| GT-401 | 25.0 | g |
| UVI-6990 | 3.8 | g |
| Crosslinked polystyrene particle of 8 μm (30%) | 14.5 | g |
| FP-149 | 0.75 | g |
| Sol Solution a-1 | 10.0 | g |
| Methyl isobutyl ketone | 38.5 | g |
| Methyl ethyl ketone | 12.0 | g |

Composition of Coating Solution A-16 for Light-Diffusing Layer

| | | |
|---|---|---|
| PET-30 | 50.0 | g |
| Irgacure 184 | 2.0 | g |
| Acrylic particle of 6 μm (30%) | 14.5 | g |
| FP-149 | 0.75 | g |
| Sol Solution a-1 | 10.0 | g |
| Toluene | 38.5 | g |
| Methyl ethyl ketone | 12.0 | g |

Composition of Coating Solution A-17 for Light-Diffusing Layer

| | | |
|---|---|---|
| PET-30 | 50.0 | g |
| Irgacure 184 | 2.0 | g |
| Acrylic particle of 8 μm (30%) | 14.5 | g |
| FP-149 | 0.75 | g |
| Sol Solution a-1 | 10.0 | g |
| Toluene | 38.5 | g |
| Methyl ethyl ketone | 12.0 | g |

Composition of Coating Solution A-18 for Light-Diffusing Layer

| | | |
|---|---|---|
| PET-30 | 50.0 | g |
| Irgacure 184 | 2.0 | g |
| Acrylic particle of 12 μm (30%) | 14.5 | g |
| FP-149 | 0.75 | g |
| Sol Solution a-1 | 10.0 | g |
| Toluene | 38.5 | g |
| Methyl ethyl ketone | 12.0 | g |

The coating solutions for light-diffusing layer above each was filtered through a polypropylene-made filter having a pore size of 10 μm to prepare a coating solution.

Composition of Comparative Coating Solution
R-1 for Light-Diffusing Layer

| | | |
|---|---|---|
| PET-30 | 50.0 | g |
| Irgacure 184 | 2.0 | g |
| SX-350H (30%) | 14.5 | g |
| FP-149 | 0.75 | g |
| Sol Solution a-1 | 10.0 | g |
| Toluene | 38.5 | g |
| Methyl ethyl ketone | 12.0 | g |

Composition of Comparative Coating Solution
R-2 for Light-Diffusing Layer

| | |
|---|---|
| PET-30 | 50.0 g |
| Irgacure 184 | 2.0 g |
| Crosslinked poly(acryl-styrene) particle 3.5 μm (30%) | 14.5 g |
| FP-149 | 0.75 g |
| Sol Solution a-1 | 10.0 g |
| Toluene | 38.5 g |
| Methyl ethyl ketone | 12.0 g |

Composition of Comparative Coating
Solution R-3 for Light-Diffusing Layer

| | |
|---|---|
| PET-30 | 50.0 g |
| Irgacure 184 | 2.0 g |
| Crosslinked polystyrene particle of 2 μm (30%) | 14.5 g |
| FP-149 | 0.75 g |
| Sol Solution a-1 | 10.0 g |
| Toluene | 38.5 g |
| Methyl ethyl ketone | 12.0 g |

The comparative coating solutions for light-diffusing layer above each was filtered through a polypropylene-made filter having a pore size of 10 μm to prepare a coating solution.

Composition of Coating Solution C-1
for Low Refractive Index Layer

| | |
|---|---|
| JTA-113 | 63.7 g |
| MEK-ST-L | 6.4 g |
| Sol Solution a-1 | 2.9 g |
| Methyl ethyl ketone | 24.5 g |
| Cyclohexanone | 2.9 g |

The coating solution above was filtered through a polypropylene-made filter having a pore size of 1 μm to prepare Coating Solution C-1 for Low Refractive Index Layer. The refractive index of the layer formed from this coating solution was 1.45.

Composition of Coating Solution C-2 for Low Refractive Index Layer

| | |
|---|---|
| Perfluoroolefin Copolymer (1) prepared | 15.0 g |
| above (solid content: 30%) | |
| X-22-164C | 0.15 g |
| Irgacure 907 | 0.23 g |
| Sol Solution a-1 | 0.6 g |
| Methyl ethyl ketone | 81.8 g |
| Cyclohexanone | 2.8 g |

The coating solution above was filtered through a polypropylene-made filter having a pore size of 1 μm to prepare Coating Solution C-2 for Low Refractive Index Layer. The refractive index of the layer formed from this coating solution was 1.43.

Composition of Coating Solution C-3 for Low Refractive Index Layer

| | |
|---|---|
| JTA-113 | 73.0 g |
| Hollow silica solution | 19.5 g |
| Sol Solution a-1 | 1.7 g |
| Methyl ethyl ketone | 47.5 g |
| Cyclohexanone | 5.3 g |

The coating solution above was filtered through a polypropylene-made filter having a pore size of 1 μm to prepare Coating Solution C-3 for Low Refractive Index Layer. The refractive index of the layer formed from this coating solution was 1.39.

The compounds used are described below.

Peltron C-4456-S7:

An ATO dispersed hardcoat agent [solid content concentration: 45%, produced by Nippon Pelnox Corporation].

KBM-5103:

A silane coupling agent (acryloxypropyltrimethoxysilane) [produced by Shin-Etsu Chemical Co., Ltd.).

PET-30:

A mixture of pentaerythritol triacrylate and pentaerythritol tetraacrylate [produced by Nippon Kayaku Co., Ltd.].

SX-500H:

A crosslinked polystyrene particle having an average particle diameter of 5 μm [refractive index: 1.60, produced by Soken Kagaku K. K., a 30% toluene liquid dispersion, used after dispersion by a polytron disperser at 10,000 rpm for 20 minutes].

Crosslinked polystyrene particle of 8 μm, Crosslinked polystyrene particle of 13 μm: Refractive index of 1.60

FP-149:

A fluorine-containing surfactant

Epoxy Compound 1:

The compound of Chem. 3 in JP-A-2004-264564.

HP-7200L:

A dicyclopentadiene-type epoxy resin (produced by Dai-Nippon Ink & Chemicals, Inc.).

GT-401:

Epolead GT-401, a tetrafunctional epoxy compound (produced by Daicel Chemical Industries, Ltd.).

MS-300K:

A crosslinked methyl methacrylate fine particle (35%- Methyl ethyl ketone dispersion liquid), average particle diameter: about 0.1 μm (produced by Soken Kagaku K. K.).

MX-150:

A 40% toluene liquid dispersion of a crosslinked acryl particle, average particle diameter: 1.5 μm (refractive index: 1.49) [produced by Soken Kagaku K. K.].

Polymethyl Methacrylate Solution (30%):

Molecular weight: 120,000 (produced by Aldrich).

SHIKO UV-6100B:

Urethane acrylate oligomer [produced by Nippon Synthetic Chemical Industry Co., Ltd.]

DPHA:

A mixture of dipentaerythritol pentaacrylate and dipentaerythritol hexaacrylate (refractive index: 1.52) [produced by Nippon Kayaku Co., Ltd.].

Irgacure 184:

A polymerization initiator [produced by Ciba Specialty Chemicals].

UVI-6990:

A cationic polymerization initiator (produced by Union Carbide Japan).

Desolite Z7404:

A hardcoat agent containing a ZrO₂ fine particle [refractive index: 1.62, solid content concentration: 60.4%, produced by JSR Corp.].

MEK-ST-L:

A colloidal silica dispersion [a product differing in the particle size from MEK-ST, average particle diameter: 45 nm, solid content concentration: 30%, produced by Nissan Chemicals Industries, Ltd.].

Hollow Silica Solution:

A KBM-5103 surface-modified hollow silica sol [surface modification ratio: 30 mass % based on silica, CS-60IPA, refractive index: 1.31, average particle diameter: 60 nm, shell thickness: 10 nm, solid content concentration: 18.2%, produced by Catalysts & Chemicals Ind. Co., Ltd.].

X22-164C:

A reactive silicone [produced by Shin-Etsu Chemical Co., Ltd.].

JTA113:

A thermal crosslinking fluorine-containing polymer containing a polysiloxane and a hydroxyl group and having a refractive index of 1.44 (solid content concentration: 6%, produced by JSR Corp.).

Irgacure 907:

A photopolymerization initiator (produced by Ciba Specialty Chemicals).

SX-350H:

A crosslinked polystyrene particle having an average particle diameter of 3.5 μm [refractive index: 1.60, produced by Soken Kagaku K. K., a 30% toluene liquid dispersion, used after dispersion by a polytron disperser at 10,000 rpm for 20 minutes].

Crosslinked Acryl-Styrene Particle 3.5 μm:

Average particle diameter: 3.5 μm [refractive index: 1.55, produced by Soken Kagaku K. K., a 30% toluene liquid dispersion, used after dispersion by a polytron disperser at 10,000 rpm for 20 minutes].

Acrylic particle of 6 μm: Crosslinked poly(methyl methacrylate) particles having an average particle diameter of 6 μm [refractive index: 1.49, a 30% toluene liquid dispersion, used after dispersion by a polytron disperser at 10,000 rpm for 20 minutes].

Acrylic particle of 8 μm: Crosslinked poly(methyl methacrylate) particles having an average particle diameter of 8 μm [MB30X-8, produced by Sekisui Plastics Co., Ltd., refractive index: 1.49, a 30% toluene liquid dispersion, used after dispersion by a polytron disperser at 10,000 rpm for 20 minutes].

Acrylic particle of 12 μm: Crosslinked poly(methyl methacrylate) particles having an average particle diameter of 12 μm [MBX-12, produced by Sekisui Plastics Co., Ltd., refractive index: 1.49, a 30% toluene liquid dispersion, used after dispersion by a polytron disperser at 10,000 rpm for 20 minutes].

### Example 1

### Production and Evaluation of Antireflection Film Samples 101 to 141

(1) Coating of Antistatic Layer

A 80 μm-thick triacetyl cellulose film (Refractive index of 1.48, TAC-TD80U, produced by Fuji Photo Film Co., Ltd.) in a roll form was unrolled, and the coating solution for antistatic layer was coated thereon and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) under nitrogen purging, thereby forming an antistatic layer having a thickness of 1.3 μm.

(2) Coating of Light-Diffusing Layer

On the antistatic layer when an antistatic layer was provided as above, or directly on the unrolled 80 μm-thick triacetyl cellulose film (TAC-TD80U, produced by Fuji Photo Film Co., Ltd.) when an antistatic layer was not provided, the coating solution for light-diffusing layer shown in Table 1 was coated by the above-described die coating method using a slot die under the condition of a transportation speed of 30 m/min and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) under nitrogen purging, thereby curing the coated layer to form a light-diffusing layer. The resulting film was taken up. However, in the case of samples where Coating Solution A-12 or A-13 for Light-Diffusing Layer was coated, the film after irradiation with an ultraviolet ray was heated at 130° C. for 8 minutes and then taken up.

(3) Coating of Low Refractive Index Layer

The triacetyl cellulose film having coated thereon the antistatic layer and the light-diffusing layer was again unrolled, and the coating solution for low refractive index layer prepared above was coated thereon by the above-described die coating method using a slot die under the conditions of a transportation speed of 30 m/min, and after drying at 120° C. for 75 seconds and further drying for 10 minutes, irradiated with an ultraviolet ray at an illumination intensity of 400 mW/cm² and an irradiation dose of 240 mJ/cm² by using an air-cooled metal halide lamp of 240 W/cm (manufactured by Eye Graphics Co., Ltd.) under nitrogen purging, thereby forming a low refractive index layer having a thickness of 100 nm. The resulting film was taken up.

(Production of Optical Film Sample)

Optical film samples were produced by the above described method according to the combination of layers shown in Table 1. The coating layers starting from left in Table 1 were sequentially coated and stacked on the support.

TABLE 1

| | | | | Light-Diffusing | | Low Refractive Index | |
|---|---|---|---|---|---|---|---|
| | | Antistatic Layer | | Layer | | Layer | |
| | | Coating | Thickness | Coating | Thickness | Coating | Thickness |
| Sample No. | | Solution | (μm) | Solution | (μm) | Solution | (μm) |
| 101 | Invention | T | 1.3 | A-1 | 9 | none | — |
| 102 | Invention | T | 1.3 | A-3 | 13 | none | — |
| 103 | Invention | none | — | A-1 | 9 | none | — |
| 104 | Invention | none | — | A-2 | 9 | none | — |
| 105 | Invention | none | — | A-3 | 13 | none | — |
| 106 | Invention | none | — | A-3 | 17 | none | — |
| 107 | Invention | none | — | A-4 | 18 | none | — |
| 108 | Invention | none | — | A-5 | 17 | none | — |
| 109 | Invention | none | — | A-6 | 17 | none | — |
| 110 | Invention | none | — | A-7 | 17 | none | — |
| 111 | Invention | none | — | A-8 | 17 | none | — |
| 112 | Invention | none | — | A-9 | 17 | none | — |
| 113 | Invention | none | — | A-10 | 17 | none | — |
| 114 | Invention | none | — | A-11 | 17 | none | — |
| 115 | Invention | none | — | A-11B | 17 | none | — |
| 116 | Invention | none | — | A-12 | 17 | none | — |
| 117 | Invention | none | — | A-13 | 17 | none | — |
| 118 | Invention | none | — | A-14 | 17 | none | — |
| 119 | Invention | none | — | A-15 | 17 | none | — |
| 120 | Invention | none | — | A-16 | 17 | none | — |
| 121 | Invention | none | — | A-16 | 7 | none | — |
| 122 | Invention | none | — | A-17 | 17 | none | — |
| 123 | Invention | none | — | A-18 | 17 | none | — |
| 124 | Invention | none | — | A-1 | 9 | C-1 | 0.1 |
| 125 | Invention | none | — | A-3 | 17 | C-1 | 0.1 |
| 126 | Invention | none | — | A-3 | 27 | C-1 | 0.1 |
| 127 | Invention | none | — | A-7 | 17 | C-1 | 0.1 |
| 128 | Invention | none | — | A-9 | 17 | C-1 | 0.1 |
| 129 | Invention | none | — | A-13 | 17 | C-1 | 0.1 |
| 130 | Invention | none | — | A-7 | 17 | C-2 | 0.1 |
| 131 | Invention | none | — | A-7 | 17 | C-3 | 0.1 |
| 132 | Invention | none | — | A-16 | 17 | C-1 | 0.1 |
| 133 | Invention | none | — | A-17 | 17 | C-1 | 0.1 |
| 134 | Invention | none | — | A-18 | 17 | C-1 | 0.1 |
| 135 | Invention | none | — | A-3 | 27 | none | — |
| 136 | Comparison | none | — | A-3 | 5 | none | — |
| 137 | Comparison | none | — | R-1 | 17 | none | — |
| 138 | Comparison | none | — | R-2 | 17 | none | — |
| 139 | Comparison | none | — | R-3 | 17 | none | — |
| 140 | Comparison | none | — | R-1 | 6 | none | — |
| 141 | Comparison | none | — | A-3 | 33 | none | — |

(Saponification Treatment of Optical Film)

The samples after the coating above were subjected to the following treatment. An aqueous 1.5 mol/liter sodium hydroxide solution was prepared and kept at 55° C. Separately, an aqueous 0.01 mol/liter dilute sulfuric acid solution was prepared and kept at 35° C. The produced antireflection film was dipped in the aqueous sodium hydroxide solution for 2 minutes and then dipped in water to thoroughly wash out the aqueous sodium hydroxide solution. Subsequently, the film was dipped in the aqueous dilute sulfuric acid solution for 1 minute and then dipped in water to thoroughly wash out the aqueous dilute sulfuric acid solution. Finally, the sample was thoroughly dried at 120° C.

In this way, saponified optical films (Samples 101 to 135 of the Invention and Comparative Samples 136 to 141) were produced.

(Evaluation of Optical Film)

These obtained optical film samples were evaluated on the following items. The results are shown in Table 2.

(1) Average Reflectance

The back surface of the film was roughened with sand paper and then treated with black ink to eliminate the back surface reflection and in this state, the spectral specular reflectance on the front surface side was measured at an incident angle of 5° in the wavelength region of 380 to 780° C. by using a spectrophotometer (manufactured by JASCO Corp.). The arithmetic mean value of specular reflectances at 450 to 650 nm was used for the result.

(2) Haze

The entire haze (H), internal haze (Hi) and surface haze (Hs) of the obtained film were determined by the following measurements.

1. The entire haze value (H) of the obtained film was measured according to JIS-K7136.

2. After adding several silicone oil drops to the front surface on the low refractive index layer side and the back surface of the obtained film, the film was sandwiched from front and back by two 1 mm-thick glass plates (Microslide Glass No. S 9111, produced by Matsunami K. K.) and put into optically complete contact with two glass plates to provide a surface haze-removed state, and the haze was measured. The haze separately measured by interposing only a silicone oil between two glass plates was subtracted from the haze value obtained above, thereby calculating the internal haze (Hi) of the film.

3. The surface haze (Hs) of the film was calculated by subtracting the internal haze (Hi) determined in 2 above from the entire haze (H) measured in 1 above.

Incidentally, the haze value as used in the present invention means the entire haze (H) obtained by the above-described method.

(3) Image Sharpness

The transmitted image sharpness was measured according to JIS K7105 with an optical comb width of 0.5 mm.

(4) Black Reproduction

Using a liquid crystal display device where the polarizing plate laminated with the optical film was disposed on the viewing side surface, sensory evaluation of the black reproduction was performed. The evaluation was performed by the method of arraying a plurality of display units in series and relatively comparing these at the same time. The black tint at the power-off time and the black tint (black screen) at the power-on time each viewed from the frontal side were compared among respective films and evaluated according to the following criteria. As the black tint is stronger, the screen is judged to be more distinct.

⊚: Strong black tint and the screen appears highly distinct.

◯: Black but faintly gray-tinted and the screen appears slightly distinct.

Δ: Black but gray-tinted and the screen appears weakly distinct.

x: Significantly strong gray tint and the screen appears loosened.

(5) Antiglare Property

The entire back side of the coated surface of the obtained film was perfectly painted with a black marker ink, and the degree of blurring was evaluated according to the following criteria when a bare fluorescent lamp (8,000 cd/m²) without louver was projected from an angle of 5° and the reflected image was observed from the direction of −5° and when projected from an angle of 45° and observed from the direction of −45°.

⊚: The contour of the fluorescent lamp was slightly observed at both −5° and −45°.

◯: The contour of the fluorescent lamp was slightly observed at −5°, but a relatively clear contour was observed at −45°.

Δ: A relatively clear contour of the fluorescent lamp was observed at both of −50 and 45°.

x: The contour of the fluorescent lamp was clearly observed or glaring at both −5° and −45°.

(6) Evaluation of Pencil Hardness

As the index for scratch resistance, the evaluation of pensile hardness described in JIS K 5400 was performed. The antireflection film was subjected to moisture conditioning at a temperature of 25° C. and a humidity of 60% RH for 2 hours, and the test was then performed under a load of 1 kg by using a 3H pencil for test prescribed in JIS S 6006. The hardness was evaluated according to the following criteria.

◯: Scratches were not observed at all in the evaluation of n=5.

Δ: One or two scratches were observed in the evaluation of n=5.

x: Three or more scratches were observed in the evaluation of n=5.

(7) Curling

The optical film sample was cut into a size of 20 cm×20 cm and placed on a horizontal desk in an environment of 25° C. and 60% RH by facing up the surface where the film was lifting at four corners. After the passing of 24 hours, the distance by which the film lifted from the desk surface at four corners was measured by means of a ruler, and the average thereof was determined. The average value was classified and evaluated according to the following criteria.

⊚: less than 5 mm

◯: from 5 to less than 10 mm

◯Δ: from 10 to less than 20 mm

Δ: from 20 to less than 40 mm

x: 40 mm or more

(8) Evaluation of Dust Attachment

The transparent support side of the optical film sample was laminated on the CRT surface and used for 24 hours in a room having from 100 to 2,000,000 dust and tissue paper scraps of 0.5 μm or more per 1 ft³ (cubic feet). The number of dust and tissue paper scrapes attached per 100 cm² of the antireflection film was measured, and the average value of the results of each sample was evaluated as follows.

⊚: less than 20

◯: from 20 to 49

Δ: from 50 to 199

x: 200 or more

(9) Evaluation of Contact Angle and Fingerprint Attachment

As the index for the antifouling property of the surface, the optical material after moisture conditioning at 25° C. and 60% RH for 2 hours was subjected to the measurement of contact angle with water. Also, a fingerprint was attached to the surface of this sample and then wiped off with a cleaning cloth and by observing the state there, the fingerprint attachment was evaluated as follows.

◯: The fingerprint could be completely wiped off.

Δ: The fingerprint was slightly observed.

x: The fingerprint could be hardly wiped off.

TABLE 2

| | | Average | Entire | Surface | Image | Black | | | | | Contact | |
|---|---|---|---|---|---|---|---|---|---|---|---|---|
| | | Reflectance | Haze | Haze | Sharpness | Reproduc- | Antiglare | Pencil | | Dust | Angle | Fingerprint |
| Sample No. | | (%) | (%) | (%) | (%) | tion | Property | Hardness | Curling | Attachment | (°) | Attachment |
| 101 | Invention | 2.4 | 55 | 2.5 | 54 | ◯ | ◯ | Δ | ◯Δ | ⊚ | 91 | Δ |
| 102 | Invention | 2.2 | 53 | 2.5 | 50 | ⊚ | ⊚ | ◯ | Δ | ⊚ | 92 | Δ |
| 103 | Invention | 2.5 | 58 | 2.3 | 55 | ◯ | ◯ | Δ | ◯Δ | Δ | 90 | Δ |
| 104 | Invention | 2.3 | 54 | 2.9 | 51 | ⊚ | ◯ | ◯ | ◯Δ | Δ | 91 | Δ |
| 105 | Invention | 2.1 | 43 | 2.5 | 53 | ⊚ | ⊚ | ◯ | Δ | Δ | 91 | Δ |
| 106 | Invention | 2.5 | 42 | 1.6 | 61 | ⊚ | ⊚ | ◯ | Δ | Δ | 92 | Δ |
| 107 | Invention | 2.2 | 41 | 2.5 | 74 | ⊚ | ⊚ | ◯ | Δ | Δ | 91 | Δ |
| 108 | Invention | 2.5 | 48 | 2.5 | 56 | ⊚ | ⊚ | ◯ | ◯ | Δ | 91 | Δ |
| 109 | Invention | 2.4 | 52 | 3.1 | 53 | ⊚ | ⊚ | ◯ | ⊚ | Δ | 91 | Δ |
| 110 | Invention | 2.4 | 48 | 2.5 | 53 | ⊚ | ⊚ | ◯ | ⊚ | Δ | 90 | Δ |
| 111 | Invention | 2.2 | 48 | 2.7 | 55 | ⊚ | ⊚ | ◯ | ⊚ | Δ | 90 | Δ |
| 112 | Invention | 2.5 | 49 | 2.4 | 53 | ⊚ | ⊚ | ◯ | ⊚ | Δ | 90 | Δ |
| 113 | Invention | 2.4 | 48 | 2.5 | 55 | ⊚ | ⊚ | ◯ | ◯ | Δ | 90 | Δ |
| 114 | Invention | 2.6 | 44 | 2.2 | 53 | ⊚ | ⊚ | ◯ | ⊚ | Δ | 91 | Δ |
| 115 | Invention | 2.6 | 45 | 2.3 | 52 | ⊚ | ⊚ | ◯ | ⊚ | Δ | 91 | Δ |
| 116 | Invention | 2.4 | 45 | 2.3 | 54 | ⊚ | ⊚ | ◯ | ⊚ | Δ | 91 | Δ |
| 117 | Invention | 2.5 | 48 | 2.5 | 58 | ⊚ | ⊚ | ◯ | ⊚ | Δ | 92 | Δ |
| 118 | Invention | 2.5 | 46 | 2.3 | 53 | ⊚ | ⊚ | ◯ | Δ | Δ | 91 | Δ |
| 119 | Invention | 2.6 | 48 | 2.5 | 54 | ⊚ | ⊚ | ◯ | ⊚ | Δ | 98 | Δ |
| 120 | Invention | 2.6 | 45 | 2.4 | 53 | ⊚ | ◯ | ◯ | ⊚ | Δ | 90 | Δ |
| 121 | Invention | 2.6 | 45 | 2.4 | 53 | ⊚ | ◯ | Δ | ⊚ | Δ | 91 | Δ |
| 122 | Invention | 2.5 | 45 | 2.5 | 54 | ⊚ | ◯ | ◯ | ⊚ | Δ | 91 | Δ |
| 123 | Invention | 2.6 | 43 | 2.5 | 55 | ⊚ | ◯ | ◯ | ⊚ | Δ | 90 | Δ |
| 124 | Invention | 1.8 | 48 | 2.5 | 54 | ⊚ | ◯ | Δ | ◯Δ | ◯ | 98 | ◯ |
| 125 | Invention | 1.9 | 48 | 2.1 | 53 | ⊚ | ⊚ | ◯ | Δ | ◯ | 98 | ◯ |
| 126 | Invention | 1.9 | 58 | 0.9 | 86 | ⊚ | Δ | ◯ | Δ | ◯ | 97 | ◯ |
| 127 | Invention | 1.8 | 42 | 1.7 | 53 | ⊚ | ⊚ | ◯ | ⊚ | ◯ | 97 | ◯ |
| 128 | Invention | 1.9 | 48 | 1.5 | 55 | ⊚ | ⊚ | ◯ | ⊚ | ◯ | 98 | ◯ |
| 129 | Invention | 1.9 | 44 | 2.0 | 53 | ⊚ | ⊚ | ◯ | ⊚ | ◯ | 99 | ◯ |
| 130 | Invention | 1.8 | 48 | 1.8 | 52 | ⊚ | ⊚ | ◯ | ⊚ | ◯ | 98 | ◯ |
| 131 | Invention | 1.9 | 48 | 1.7 | 53 | ⊚ | ⊚ | ◯ | ⊚ | ◯ | 98 | ◯ |
| 132 | Invention | 1.9 | 44 | 2.2 | 53 | ⊚ | ◯ | ◯ | ⊚ | ◯ | 98 | ◯ |
| 133 | Invention | 1.9 | 44 | 2.3 | 53 | ⊚ | ◯ | ◯ | ⊚ | ◯ | 98 | ◯ |
| 134 | Invention | 1.9 | 43 | 2.4 | 53 | ⊚ | ◯ | ◯ | ⊚ | ◯ | 99 | ◯ |
| 135 | Invention | 2.6 | 59 | 0.8 | 76 | ⊚ | Δ | ◯ | Δ | ◯ | 88 | Δ |
| 136 | Comparison | 2.7 | 37 | 18.7 | 20 | X | ◯ | X | ⊚ | Δ | 89 | X |
| 137 | Comparison | 2.7 | 42 | 0.3 | 96 | Δ | X | ◯ | Δ | Δ | 89 | X |
| 138 | Comparison | 2.7 | 38 | 0.3 | 96 | Δ | X | ◯ | Δ | Δ | 89 | X |
| 139 | Comparison | 2.9 | 37 | 0.2 | 96 | Δ | X | ◯ | Δ | Δ | 89 | X |
| 140 | Comparison | 2.4 | 62 | 10.7 | 18 | X | ◯ | X | ⊚ | Δ | 89 | Δ |
| 141 | Comparison | 2.4 | 62 | 0.5 | 91 | ⊚ | X | ◯ | X | Δ | 89 | Δ |

The results in Table 2 reveal the followings.

In the optical film of the present invention, the optical performance as the antireflection film (average reflectance, surface haze, image sharpness, black reproduction, antiglare property) is in the desired range, the hardness of the coated film is high, the scratch resistance by pencil and the like is excellent, and the curling is small. Furthermore, the film where a low refractive index layer is stacked on the light-diffusing layer is excellent in the resistance against fingerprint attachment, and the film where an antistatic layer is provided below the light-diffusing layer is excellent also in the resistance against dust attachment.

Such an optical film excellent in the overall performance as the antireflection film can be for the first time obtained by the present invention.

### Example 2

A 80 μm-thick triacetyl cellulose film (TAC-TD80U, produced by Fuji Photo Film Co., Ltd.) which had been dipped in an aqueous 1.5 mol/liter NaOH solution at 55° C. for 2 minutes and after neutralization, washed with water, and each film of the (saponified) samples of the present invention produced in Example 1 were bonded for protection to both surfaces of a polarizing film produced by adsorbing iodine to polyvinyl alcohol and stretching the film. In this way, a polarizing plate was produced. The thus-produced polarizing plate was laminated to replace the polarizing plate on the viewing side of a liquid crystal display device (where “D-BEF” produced by Sumitomo 3M Ltd., which is a polarizing separation film with a polarization selective layer, is provided between the backlight and the liquid crystal cell) of a note-type personal computer having mounted thereon a transmissive TN liquid crystal display device, such that the light-diffusing layer or the low refractive index layer is disposed on the viewing side. As a result, a display device with extremely reduced projection of surrounding scene and very high display quality was obtained.

### Example 3

A PVA film was dipped in an aqueous solution containing 2.0 g/liter of iodine and 4.0 g/liter of potassium iodide at 25° C. for 240 seconds and further dipped in an aqueous solution containing 10 g/liter of boric acid at 25° C. for 60 seconds. Subsequently, the film was introduced into a tenter stretching machine in the mode shown in FIG. 2 of JP-A-2002-86554 and 5.3-fold stretched. Then, the tenter was bent as shown in FIG. 2 with respect to the stretching direction and thereafter, the width was kept constant. The film was dried in an atmosphere at 80° C. and removed from the tenter. The difference in the transportation speed between right and left tenter clips was less than 0.05% and the angle made by the center line of the film introduced and the center line of the film delivered to the next step was 46°. Here, |L1-L2| was 0.7 m, W was 0.7 m and a relationship of |L1-L2|=W was established. The substantial stretching direction Ax-Cx at the tenter outlet was inclined at 45° with respect to the center line 22 of the film delivered to the next step. At the tenter outlet, wrinkling and film deformation were not observed.

The film was laminated with saponified FUJITAC (cellulose triacetate, retardation value: 3.0 nm) produced by Fuji Photo Film Co., Ltd., by using a 3% aqueous solution of PVA (PVA-117H produced by Kuraray Co., Ltd.) as the adhesive, and the resulting laminate was dried at 80° C. to obtain a polarizing plate having an effective width of 650 mm. The absorption axis direction of the obtained polarizing plate was inclined at 45° with respect to the longitudinal direction. The transmittance of this polarizing plate at 550 nm was 43.7% and the polarization degree was 99.97%. Furthermore, the polarizing plate was cut into a size of 310×233 mm, as a result, a polarizing plate having an absorption axis inclined at 45° with respect to the side could be obtained with an area efficiency of 91.5%.

Subsequently, each film of the (saponified) samples produced in Example 1 was laminated with this polarizing plate to produce a polarizing plate having antireflection property. Using this polarizing plate, a liquid crystal display device was produced by disposing the antireflection layer as the outermost layer, as a result, the samples of the present invention ensured excellent contrast due to no reflection of outside light and high visibility with indistinguishable reflected image.

In the case of the polarizing plate laminated with the film of Sample 141 which is a comparative sample, large curling was generated and on one day after the polarizing plate was disposed in the liquid crystal display, the laminated surface was separated at the corner portions.

### Example 4

In a transmissive TN liquid crystal cell laminated with each film of the samples of the present invention produced in Example 1, an optical compensation film (Wide View Film Ace, produced by Fuji Photo Film Co., Ltd.) was used for the protective film on the liquid crystal cell side of the polarizing plate on the viewing side as well as for the protective film on the liquid crystal cell side of the polarizing plate on the backlight side, as a result, a liquid crystal display device assured of excellent contrast in bright room, a very wide viewing angle in the up/down and light/left directions, remarkably excellent visibility and high display quality was obtained.

Also, samples 123 to 133 of the present invention had a light-scattering intensity at 30° of 0.06% based on an outgoing angle of 0° and by virtue of this light-diffusing property, the liquid crystal display device was a very good liquid crystal display with enlarged viewing angle in the down direction and improved yellow tinting in the right/left directions.

### Example 5

Cellulose Acylate Sample 201 having a thickness of 80 μm was produced according to a co-casting method by using a cellulose acylate having an acetyl substitution degree of 2.94 and using Optical Anisotropy Decreasing Agent A-19 to account for 49.3% (based on the cellulose acylate) and Wavelength Dispersion Adjusting Agent UV-102 to account for 7.6% (based on the cellulose acylate). The retardation Re of the obtained film was −1.0 nm (since the slow axis is in the TD direction, shown by a negative value) and the retardation Rth in the thickness direction was −2.0 nm. Thus, both were a sufficiently small value. This cellulose acylate film sample was used as the transparent support of the protective film on the cell side out of two protective film of a polarizer, and each film of the samples of the present invention produced in Example 1 was used for the protective film on the viewing side of the polarizer, as a result, good contrast and viewing angle performances were obtained in all of the evaluations performed with the liquid crystal display device described in Example 1 of JP-A-1048420, the alignment film prepared by coating a discotic liquid crystal molecule-containing optically anisotropic layer on polyvinyl alcohol described in Example 1 of JP-A-9-26572, the VA-type liquid crystal display shown in FIGS. 2 to 9 of JP-A-2000-154261, and the OCB-type liquid crystal display device shown in FIGS. 10 to 15 of JP-A-2000-154261.

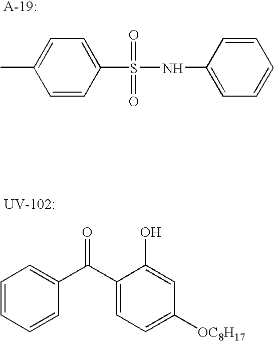

### Example 6

Each film of the samples of the present invention produced in Example 1 was laminated to a glass plate on the surface of an organic EL display device through a pressure-sensitive adhesive, as a result, a display device reduced in the reflection on the glass surface and assured of high visibility was obtained.

### Example 7

A polarizing plate having an antireflection film on one surface was produced by using each film of the samples of the present invention produced in Example 1, a λ/4 plate was laminated on the polarizing plate surface opposite the side having the light-diffusing layer or the low refractive index layer, and the resulting polarizing plate was laminated to a glass plate on the surface of an organic EL display device so that the light-diffusing layer or the low refractive index layer is disposed on the viewing side, as a result, surface reflection and reflection from the inside of the surface glass were cut and a display with remarkably high visibility was obtained.

The optical film of the present invention has a high film hardness and at the same time, stably exhibits a necessary optical performance. Also, a display to which the optical film is applied is excellent in the black reproduction. Furthermore, a display device equipped with the antireflection film of the present invention and a display device equipped with a polarizing plate using the optical film of the present invention are reduced in the reflection of outside light or the projection of surrounding scenes and assured of very high visibility, less display unevenness and high display grade.

The entire disclosure of each and every foreign patent application from which the benefit of foreign priority has been claimed in the present application is incorporated herein by reference, as if fully set forth.

What is claimed is:

1. An optical film comprising:
a transparent support; and
a light-diffusing layer comprising a first light-transparent resin particle and a binder,
wherein the first light-transparent resin particle has an average particle diameter of from 5 to 15 μm,
the light-diffusing layer has a film thickness of from 8 to 30 μm, and
a haze of a surface, on the side coated with the light-diffusing layer, of the optical film is from 0 to 10%.

2. The optical film as claimed in claim 1,
wherein the light-diffusing layer has a film thickness of 8 to 18 μm.

3. The optical film as claimed in claim 1, which has an image sharpness of 30 to 95% as measured with an optical comb width of 0.5 mm.

4. The optical film as claimed in claim 1,
wherein the light-diffusing layer comprises, as the binder, an epoxy-based resin having two or more epoxy groups within one molecule in an amount of 20 to 100 mass % based on all binders.

5. The optical film as claimed in claim 1,
wherein the difference between refractive index of the first light-transparent resin particle and refractive index of the binder is from 0.02 to 0.3.

6. The optical film as claimed in claim 1,
wherein the light-diffusing layer further comprises a second light-transparent resin particle having a refractive index difference of less than 0.02 from refractive index of the binder.

7. The optical film as claimed in claim 6,
wherein the second light-transparent resin particle is contained in an amount of 20 to 70 mass % based on all binders in the light-diffusing layer.

8. The optical film as claimed in claim 1,
wherein the light-diffusing layer is formed by coating and curing a coating composition for the light-diffusing layer, the coating composition comprising a high-molecular weight compound selected from cellulose esters, acrylic acid esters, urethane acrylates and polystyrene in an amount of 10 to 60 mass % based on all binders.

9. The optical film as claimed in claim 1,
wherein the light-diffusing layer is formed by coating and curing a coating composition for the light-diffusing layer, the coating composition comprising an organosilicon compound represented by formula (2) or a polymer thereof:
Formula (2):
R²ₘSi(OR¹)₄₋ₘ
(wherein R¹ and R², which may be the same or different, each represents a substituted or unsubstituted alkyl group, and m is 0 or 1).

10. The optical film as claimed in claim 1,
wherein the light-diffusing layer comprises an inorganic filler comprising a metal oxide.

11. The optical film as claimed in claim 1,
wherein a surface contact angle, on the side coated with said light-diffusing layer, of the optical film is 90° or more.

12. An antireflection film which is the optical film claimed in claim 1, further comprising
a low refractive index layer having a refractive index layer lower than that of the support, so that the transparent support, the light-diffusing layer and the low refractive index layer are arranged in this order.

13. A polarizing plate comprising:
a polarizing layer; and
two protective films for the polarizing layer,
wherein at lease one of the two protective films is the optical film as claimed in claim 1.

14. A polarizing plate comprising:
a polarizing layer; and
two protective films for the polarizing layer,
wherein at lease one of the two protective films is the antireflection film as claimed in claim 12.

15. A display device comprising the optical film as claimed in claim 1,
wherein the light-diffusing layer is disposed to come to a viewing side of the display device.

16. A display device comprising the antireflection film as claimed in claim 12,
wherein the low refractive index layer is disposed to come to the viewing side of the display device.

17. A display device comprising the polarizing plate claimed in claim 13,
wherein the light-diffusing layer is disposed to come to a viewing side of the display device.

18. A display device comprising the polarizing plate claimed in claim 14,
wherein the low refractive index layer is disposed to come to the viewing side of the display device.
